(19) United States
(12) Patent Application Publication
(10) Pub. No.: US 2024/0281222 A1
(43) Pub. Date: Aug. 22, 2024

(54) ARTIFICIAL INTELLIGENCE SYSTEM FOR GENERATING DATABASE CODE FROM NATURAL LANGUAGE INPUTS

(71) Applicant: Cornell University, Ithaca, NY (US)

(72) Inventor: Immanuel Trummer, Ithaca, NY (US)

(21) Appl. No.: 18/583,394

(22) Filed: Feb. 21, 2024

Related U.S. Application Data
(60) Provisional application No. 63/447,172, filed on Feb. 21, 2023.

(51) Int. Cl. G06F 8/35

(52) U.S. Cl. CPC G06F 8/35

(57) ABSTRACT

An apparatus comprises at least one processing device that includes a processor coupled to a memory. The at least one processing device is configured to receive natural language input from one or more user devices relating at least in part to data of one or more databases, to apply the natural language input to an artificial intelligence (AI) system, to generate in the AI system database code for the one or more databases based at least in part on the natural language input, and to execute the generated database code against at least a portion of the one or more databases. The natural language input may be received in association with a database query, which is decomposed into a sequence of processing steps formulated in natural language using corresponding text templates, and from which one or more prompts are generated for application to the AI system.

### RELATED APPLICATION

The present application claims priority to U.S. Provisional Patent Application Ser. No. 63/447,172, filed Feb. 21, 2023 and entitled “Artificial Intelligence System for Generating Database Code from Natural Language Inputs,” which is incorporated by reference herein in its entirety.

### FIELD

The field relates generally to information processing systems, and more particularly to artificial intelligence (AI) techniques implemented in such systems.

### BACKGROUND

Modifying a database management system under conventional practice can be a very difficult task. For example, database management systems such as PostgreSQL (“Postgres”), where SQL denotes Structured Query Language, typically feature millions of code lines. Understanding and changing that code generally requires expert knowledge in databases on top of advanced coding skills. This prevents all but the most experienced developers from creating customized versions of such database management systems. Accordingly, improved techniques are needed for generating database code for database management systems and other code execution environments.

### SUMMARY

Illustrative embodiments disclosed herein provide AI systems for generating database code from natural language inputs. For example, in some embodiments, an AI system is configured to generate customized data processing code, for one or more database management systems or other code execution environments, utilizing natural language inputs provided by one or more system users.

One or more such embodiments advantageously overcome the above-noted drawbacks of conventional practice by providing an AI framework configured to generate customized code for data processing in a database management system or other code execution environment based at least in part on user inputs provided in natural language.

In one embodiment, an apparatus illustratively comprises at least one processing device that includes a processor coupled to a memory. The at least one processing device is configured to receive natural language input from one or more user devices relating at least in part to data of one or more databases, to apply the natural language input to an AI system, to generate in the AI system database code for the one or more databases based at least in part on the natural language input, and to execute the generated database code against at least a portion of the one or more databases.

In some embodiments, executing the generated database code illustratively comprises providing the generated database code to a database management system associated with the one or more databases for execution therein. Numerous other execution arrangements utilizing other types of code execution environments can be used in other embodiments.

In some embodiments, receiving natural language input from one or more user devices comprises receiving the natural language input in association with at least one database query.

The at least one processing device in some embodiments is further configured to decompose the at least one database query into a sequence of processing steps formulated in natural language using one or more corresponding text templates.

The at least one processing device in some embodiments is further configured to generate one or more prompts for application to the AI system at least in part by interleaving at least a portion of the sequence of processing steps with one or more user-provided instructions of the natural language input, wherein at least one of the one or more prompts further comprises at least one of (i) information characterizing one or more database schema, (ii) information characterizing one or more physical data properties, (iii) one or more generic instructions regarding corresponding relational operators, and (iv) one or more code samples.

In these and other embodiments, applying the natural language input to the AI system illustratively comprises applying the one or more prompts to the AI system for generation of the database code therefrom.

The AI system in some embodiments is configured in accordance with a Generative Pretrained Transformer (GPT) model, although other types of models can be used in other embodiments. For example, other embodiments can utilize additional or alternative neural network models based on a transformer architecture.

Additionally or alternatively, receiving natural language input from one or more user devices in some embodiments comprises receiving at least one of one or more general instructions in natural language and one or more per-step instructions in natural language via at least one user interface of the at least one processing device.

A given one of the general instructions may comprise, for example, an instruction specifying at least one particular library to be utilized in processing at least one database query.

A given one of the per-step instructions may comprise, for example, an instruction specifying customized logging output.

In some embodiments, the at least one processing device is further configured to receive termination condition information from the one or more user devices, the termination condition information specifying one or more termination criteria associated with automated verification operations performed on generated database code by the AI system, and wherein generating the database code comprises generating the database code in a manner that complies with the one or more termination criteria specified in the received termination condition information.

Additionally or alternatively, the at least one processing device in some embodiments is further configured to implement an automated debugging system for debugging at least portions of the database code.

The automated debugging system in some embodiments is illustratively configured to apply a probabilistic model to identify one or more portions of the database code that have at least a threshold likelihood of being incorrect and to control regeneration of the one or more identified portions.

The automated debugging system in some embodiments is additionally or alternatively configured to schedule execution of one or more test cases in conjunction with identifying one or more portions of the database code that have at least a threshold likelihood of being incorrect.

In some embodiments, the at least one processing device is further configured to utilize at least a portion of the generated database code as a code sample for use in generation of additional database code by the AI system.

In some embodiments, the at least one processing device is further configured, for each of one or more database queries, to obtain a first query result for the database query utilizing a reference database management system, to obtain a second query result for the database query utilizing a database management system comprising the generated database code, to compare the first and second query results, and to determine correctness of the generated database code based at least in part on the comparison.

The at least one processing device in some embodiments is further configured to combine the database code generated by the AI system with additional database code.

It is to be appreciated that the foregoing arrangements are only examples, including examples of potential applications of the disclosed techniques, and numerous alternative arrangements are possible.

These and other illustrative embodiments include but are not limited to systems, methods, apparatus, processing devices, integrated circuits, and computer program products comprising processor-readable storage media having software program code embodied therein.

### BRIEF DESCRIPTION OF THE FIGURES

FIG. 1 is a block diagram of an information processing system comprising a processing platform configured to implement an AI system for generating database code using natural language inputs in an illustrative embodiment.

FIG. 2 is a block diagram of an example AI system for generating database code using natural language inputs in an illustrative embodiment.

FIG. 3 shows an example prompt for code generation in an AI system in an illustrative embodiment.

FIG. 4 shows example code generated utilizing the AI system of FIG. 2 in response to the example prompt of FIG. 3 in an illustrative embodiment.

FIG. 5 is a block diagram of another example AI system for generating database code using natural language inputs in an illustrative embodiment.

FIG. 6 shows pseudocode of an example algorithm for generating SQL execution engines based on natural language instructions in an illustrative embodiment.

FIG. 7 shows an example prompt and associated example code generated utilizing the AI system of FIG. 5 in an illustrative embodiment.

FIG. 8 shows pseudocode of an example algorithm for generating a prompt for operator synthesis in an illustrative embodiment.

FIG. 9 shows pseudocode of an example algorithm for synthesizing operator code in an illustrative embodiment.

FIG. 10 shows pseudocode of an example algorithm for validating engines via test cases in an illustrative embodiment.

FIG. 11 shows example dependencies between tests and operators in an illustrative embodiment.

FIG. 12 shows pseudocode of an example algorithm for comparing test cases to determine priority in an illustrative embodiment.

FIG. 13 is a flow diagram of an example debugging process for identifying faulty operators in an illustrative embodiment.

FIG. 14 shows pseudocode of an example algorithm for re-generating possibly faulty operators in an illustrative embodiment.

### DETAILED DESCRIPTION

Illustrative embodiments can be implemented, for example, in the form of information processing systems comprising one or more processing platforms each having at least one computer, server or other processing device. A number of examples of such systems will be described in detail herein. It should be understood, however, that embodiments disclosed herein are more generally applicable to a wide variety of other types of information processing systems and associated computers, servers or other processing devices or other components. Accordingly, the term “information processing system” as used herein is intended to be broadly construed so as to encompass these and other arrangements.

Also, the particular embodiments described herein are illustrative examples only, and should not be construed as limiting in any way.

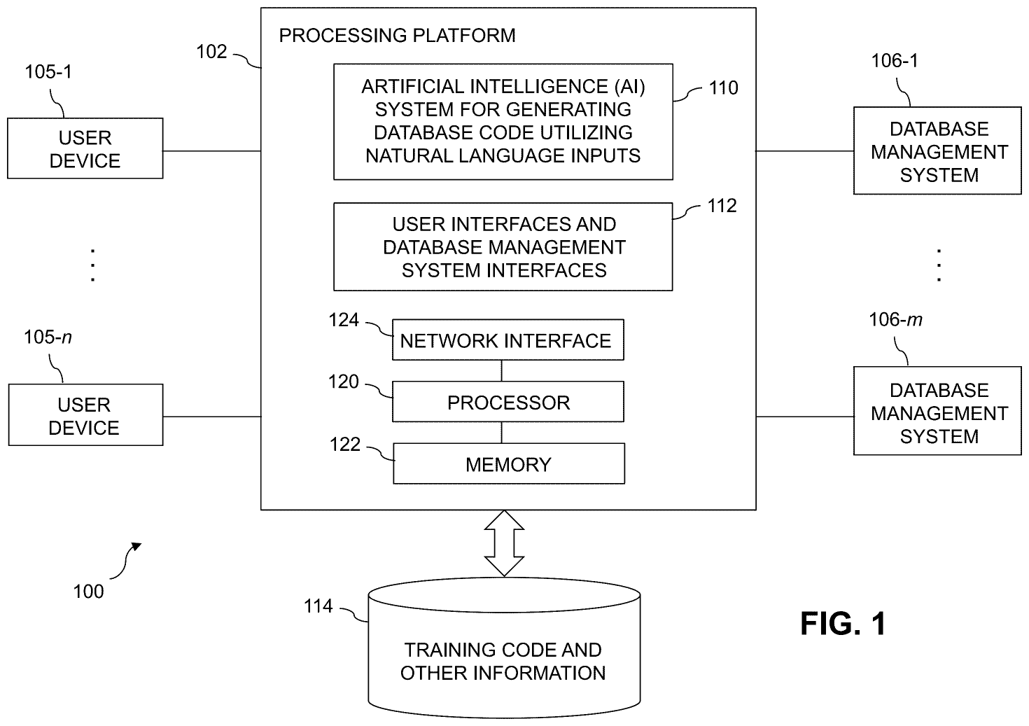

FIG. 1 shows an information processing system 100 comprising a processing platform 102.

Coupled to the processing platform 102 are user devices 105-1, . . . 105-n and database management systems 106-1, . . . 106-m, where n and m are arbitrary integers greater than or equal to two and may but need not be equal. Other embodiments can include only a single user device and/or only a single database management system. Additionally or alternatively, different ones of the user devices 105 and the database management systems 106 may represent the same processing device, or different components of that same processing device, such as a computer or other processing device of a particular system user. A given database management system may also be referred to herein as a DBMS.

The processing platform 102 comprises an AI system 110 and a set of interfaces 112. The AI system 110 in the present embodiment more particularly comprises a generative AI system configured for generating database code utilizing natural language inputs, as described in more detail elsewhere herein, illustratively based on a generative AI model such as the GPT-3 Codex model from OpenAI, where GPT denotes Generative Pretrained Transformer. It is to be appreciated, however, that GPT models used in some embodiments herein are only examples, and that other embodiments can utilize additional or alternative machine learning models or other AI models, such as, also by way of example, other types of neural network models based on a transformer architecture.

The set of interfaces 112 more particularly comprises user interfaces and database management interfaces, for interfacing the processing platform 102 with the user devices 105 and the database management systems 106, respectively. Natural language inputs are illustratively received in the processing platform 102 from one or more of the user devices 105 via one or more user interfaces of the set of interfaces 112. The resulting generated code is illustratively supplied to one or more of the database management systems 106 for incorporation therein as data processing code of the database management systems 106.

In operation, the processing platform 102 is illustratively configured to receive natural language input from one or more of the user devices 105 relating at least in part to data of one or more databases, to apply the natural language input to the AI system 110, to generate in the AI system 110 database code for the one or more databases based at least in part on the natural language input, and to execute the generated database code against at least a portion of the one or more databases.

In some embodiments, executing the generated database code illustratively comprises providing the generated database code to at least one of the database management systems 106 associated with the one or more databases for execution therein. Numerous other execution arrangements utilizing other types of code execution environments can be used in other embodiments.

Examples of database management systems 106 that can be used in illustrative embodiments include Postgres, MySQL, Oracle Database, etc.

It is to be appreciated that the term “AI system” as used herein is intended to be broadly construed to encompass a wide variety of different types of systems that are based at least in part on neural networks and/or other artificial intelligence techniques, including by way of example generative AI systems, other types of machine learning systems and/or other types of AI systems configured to generate database code for one or more database management systems as disclosed herein. More detailed examples of particular implementations of AI system 110 are described elsewhere herein.

Also, the term “database code” as used herein is intended to be broadly construed so as to encompass, for example, data processing code and other types of code associated with accessing data in one or more databases. Database code is therefore intended to encompass, for example, sets of one or more SQL queries and/or one or more SQL execution engines, as well as additional or alternative code arrangements.

Furthermore, the term “database management system” as used herein is similarly intended to be broadly construed so as to encompass, for example, a processing system that is separate from one or more databases or a processing system that is at least partially integrated with one or more databases.

As one illustration of the manner in which the term “database management system” is broadly used herein, a given such database management system in some embodiments can comprise, for example, a thin wrapper around a Python interpreter. Such an arrangement is illustratively configured to execute AI-generated Python code, and to extract one or more query results from at least one file generated as result of the execution. Numerous alternative database management systems can be used in other embodiments, including a wide variety of different conventional implementations of database management systems that are known to those skilled in the art.

As indicated above, numerous other execution arrangements can be used in other embodiments for execution of the generated database code. For example, in some embodiments, the generated code could be in a general-purpose programming language like Python and executed on comma-separated values files that reside on one or more disks or other storage devices within information processing system 100.

Although shown as separate from the processing platform 102, at least one of the database management systems 106 can be implemented at least in part on the processing platform 102. For example, in some embodiments, the same processing platform can implement not only the AI system 110 and the set of interfaces 112, but also at least one of the database management systems 106. In such an embodiment, the portions of the set of interfaces 112 that interface with the at least one database management system comprise one or more internal interfaces of the processing platform 102.

The processing platform 102 is also configured to utilize a database 114 of training code and other information. For example, such a database can comprise database code utilized in training of the AI system 110 as well as additional information characterizing system users associated with respective ones of the user devices 105 as well as other information characterizing the database management systems 106 supported by the processing platform 102. Database code generated by the AI system 110 can also be stored in the database 114 and utilized as part of the training code for subsequent additional training of the AI system 110. The database 114 in the present embodiment is considered separate from one or more other databases that are associated with the database management systems 106 and that contain data that is accessed at least in part utilizing database code generated by the AI system 110 and provided to the database management systems 106.

The database management systems 106 contain database code at least portions of which are generated in an automated manner by the AI system 110 based at least in part on natural language inputs from one or more of the user devices 105.

In some embodiments, receiving natural language input from one or more of the user devices 105 comprises receiving the natural language input in association with at least one database query.

The processing platform 102 in some embodiments is configured to decompose the at least one database query into a sequence of processing steps formulated in natural language using one or more corresponding text templates.

The processing platform 102 illustratively generates one or more prompts for application to the AI system 110 at least in part by interleaving at least a portion of the sequence of processing steps with one or more user-provided instructions of the natural language input. The one or more prompts can comprise additional information, such as, for example, at least one of information characterizing one or more database schema (e.g., table names, column configurations, etc.), information characterizing one or more physical data properties (e.g., paths to .csv files containing actual data), one or more generic instructions specifying how corresponding relational operators work (e.g., their inputs, outputs and semantics), and/or one or more code samples. Other types of additional or alternative information can be incorporated into a given prompt for application to the AI system 110 utilizing the techniques disclosed herein.

In some embodiments, applying the natural language input to the AI system 110 comprises applying the one or more prompts to the AI system 110 for generation of the database code therefrom.

Additionally or alternatively, receiving natural language input from one or more of the user devices 105 illustratively comprises receiving at least one of one or more general instructions in natural language and one or more per-step instructions in natural language via at least one user interface of the set of interfaces 112.

By way of example, a given one of the general instructions may comprise an instruction specifying at least one particular library to be utilized in processing at least one database query.

As another example, a given one of the per-step instructions may comprise an instruction specifying customized logging output.

Numerous other types of general instructions and per-step instructions may be provided as part of the natural language input in other embodiments.

Also, it is to be appreciated that a wide variety of other types of natural language input can additionally or alternatively be used in other embodiments. For example, some embodiments process natural language input that does not describe one or more SQL queries or other types of database queries, but instead describes one or more desired properties of a system for processing such queries.

In some embodiments, the processing platform 102 is configured to receive termination condition information from one or more of the user devices 105, with the termination condition information specifying one or more termination criteria associated with automated verification operations performed on generated database code by the AI system 110. In one or more such embodiments, generating the database code illustratively comprises generating the database code in a manner that complies with the one or more termination criteria specified in the received termination condition information.

Additionally or alternatively, the processing platform 102 in some embodiments is configured to implement an automated debugging system for debugging at least portions of the database code. For example, the automated debugging system is illustratively configured to apply a probabilistic model to identify one or more portions of the database code that have at least a threshold likelihood of being incorrect, and to control regeneration of the one or more identified portions.

The automated debugging system in some embodiments is configured to schedule execution of one or more test cases in conjunction with identifying one or more portions of the database code that have at least a threshold likelihood of being incorrect.

Accordingly, the automated debugging system in some embodiments identifies code portions for which the AI system appears to have made a mistake and automatically causes the AI system 110 to regenerate those portions.

In some embodiments, the processing platform 102 utilizes at least a portion of the generated database code as a code sample for use in generation of additional database code by the AI system 110.

The processing platform 102 in some embodiments is illustratively configured, for each of one or more database queries, to obtain a first query result for the database query utilizing a reference database management system, to obtain a second query result for the database query utilizing a database management system comprising the generated database code, to compare the first and second query results, and to determine correctness of the generated database code based at least in part on the comparison.

For example, the processing platform 102 can perform such code verification over multiple test cases. In one such arrangement, given an SQL query, the processing platform 102 obtains a result using a reference database management system (e.g., Postgres), then compares that result to the result obtained by executing AI-generated code. If the two results are equivalent, for one or more test cases, the AI-generated code is likely correct. Some embodiments are configured to perform such code verification for a current query, while other embodiments are configured to perform such code verification using multiple sets of test queries.

Additionally or alternatively, the processing platform 102 in some embodiments is configured to combine the database code generated by the AI system 110 with additional database code. For example, the processing platform 102 can be configured to mix code generated by AI system 110 with boilerplate code that integrates other AI-generated code. Numerous other arrangements for mixing AI-generated code with other database code can be used in illustrative embodiments disclosed herein.

Some embodiments are configured to generate database code in various types of programming languages. For example, a given embodiment can be configured to translate an SQL query into database code in a specified programming language, such as Python or C++, following natural language instructions on how to translate the SQL query. In such an arrangement, the input illustratively comprises the SQL query and natural language instructions, and the output comprises the generated database code in Python or C++. It is also possible for the query to be described at least in part utilizing natural language.

It should also be noted that the natural language input may but need not be specific to any particular database, but could instead relate more generally to data that may reside in one or more unspecified databases. For example, the natural language input from a given one of the user devices 105 may comprise a statement such as “show a progress bar for each data processing operation, and update at least once per second.” This example statement is not specific to any particular database and the resulting database code could be reused in conjunction with accessing data across various databases of different types.

Some embodiments are configured to utilize natural language instructions or other natural language input received from one or more of the user devices 105 as well as natural language instructions or other natural language input obtained from one or more libraries. For example, natural language instructions obtained from a given library may describe how atomic relational operators work. Such library-based information is illustratively merged with user instructions into prompts that are then used to instruct the AI system 110 on how to generate database code implementing those operators.

In some embodiments, users can provide code samples, in addition to or instead of natural language instructions, as input. Based on such code samples, the AI system 110 can learn what the desired code looks like and can generate database code for a corresponding database management system in that style.

The prompts and other features and functionality described above in conjunction with illustrative embodiments advantageously facilitate the generation of database code with a higher level of accuracy than would otherwise be possible using conventional techniques.

Although the AI system 110 and the set of interfaces 112 are both shown as being implemented on processing platform 102 in the present embodiment, this is by way of illustrative example only. In other embodiments, the AI system 110 and the set of interfaces 112 can each be implemented at least in part on one or more separate processing platforms.

A given such processing platform is assumed to include at least one processing device comprising a processor coupled to a memory. Examples of such processing devices include computers, servers or other processing devices arranged to communicate over one or more networks. Storage devices such as storage arrays or cloud-based storage systems used for implementation of one or more databases are also considered “processing devices” as that term is broadly used herein.

The network can comprise, for example, a global computer network such as the Internet, a wide area network (WAN), a local area network (LAN), a satellite network, a telephone or cable network, a cellular network such as a 4G or 5G network, a wireless network implemented using a wireless protocol such as Bluetooth, WiFi or WiMAX, or various portions or combinations of these and other types of communication networks.

It is also possible that at least portions of other system elements such as one or more of the user devices 105 and/or the database management systems 106 can be implemented as part of the processing platform 102, although shown as being separate from the processing platform 102 in the figure.

The processing platform 102 in the present embodiment further comprises a processor 120, a memory 122 and a network interface 124. The processor 120 is assumed to be operatively coupled to the memory 122 and to the network interface 124 as illustrated by the interconnections shown in the figure.

The processor 120 may comprise, for example, a microprocessor, an application-specific integrated circuit (ASIC), a field-programmable gate array (FPGA), a central processing unit (CPU), a graphics processing unit (GPU), a tensor processing unit (TPU), an arithmetic logic unit (ALU), a digital signal processor (DSP), or other similar processing device component, as well as other types and arrangements of processing circuitry, in any combination. At least a portion of the functionality of the processing platform 102, including the AI system 110 and the set of interfaces 112, as provided by one or more processing devices as disclosed herein, can be implemented using such circuitry.

In some embodiments, the processor 120 comprises one or more graphics processor integrated circuits. Such graphics processor integrated circuits are illustratively implemented in the form of one or more GPUs. Accordingly, in some embodiments, system 100 is configured to include a GPU-based processing platform. Such a GPU-based processing platform can be cloud-based and illustratively configured to implement one or more machine learning systems or other types of AI systems for generating database code from natural language inputs in the manner disclosed herein. Similar arrangements can be implemented using TPUs and/or other processing devices.

Numerous other arrangements are possible. For example, in some embodiments, an AI system can be implemented on a single processor-based device, such as a client computer or other type of user device, utilizing one or more processors of that device. Such embodiments are also referred to herein as “on-device” implementations of AI systems.

The memory 122 stores software program code for execution by the processor 120 in implementing portions of the functionality of the processing platform 102. For example, at least portions of the functionality of AI system 110 and set of interfaces 112 can be implemented using program code stored in memory 122.

A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, flash memory, read-only memory (ROM), magnetic memory, optical memory, or other types of storage devices in any combination.

Articles of manufacture comprising such processor-readable storage media are considered embodiments of the present disclosure. The term “article of manufacture” as used herein should be understood to exclude transitory, propagating signals.

Other types of computer program products comprising processor-readable storage media can be implemented in other embodiments.

In addition, illustrative embodiments may be implemented in the form of integrated circuits comprising processing circuitry configured to implement processing operations associated with one or both of the AI system 110 and the set of interfaces 112 as well as other related functionality. For example, at least a portion of the AI system 110 in some embodiments is illustratively implemented in at least one neural network integrated circuit of a processing device of the processing platform 102.

The network interface 124 is configured to allow the processing platform 102 to communicate over one or more networks with other system elements, and may comprise one or more conventional transceivers.

It is to be appreciated that the particular arrangement of components and other system elements shown in FIG. 1 is presented by way of illustrative example only, and numerous alternative embodiments are possible.

For example, other embodiments of information processing systems can be configured to implement AI system functionality for generating database code as disclosed herein.

As another example, although some embodiments utilize particular types of generative AI models, such as the GPT-3 model from OpenAI, the disclosed arrangements are readily extendable to other generative AI models such as OpenAI GPT-3.5, GPT-4.0 and numerous others, including other types of transformer-based models.

Additionally or alternatively, a given AI system as disclosed herein can be configured to generate code in any of a wide variety of different computer programming languages, including by way of example Python, C++, Java, etc. Some embodiments can generate complex database code which may be characterized at least in part as processing steps or lines, or in numerous other code formats.

In some embodiments, apparatus, methods, or computer program products are configured to solve a plurality of problems having an average correctness of 50%-100% including any value therewithin, or any subranges therebetween, or an average correctness of at least 60%, at least 70%, at least 75%, or at least 80% correct. The correctness could be defined as a percentage of correct results by comparing the results of the generated code via the presented platform to reference results or the human-verified correct results. In some embodiments, a correct result to a problem is determined by a reference result, an actual result, a human-verified result, or the difference between a result of the generated code via the presented platform and a reference result, an actual result, or a human-verified result of a problem is within or below a predetermined threshold or tolerance.

As a more particular example, some embodiments are configured to generate code that produces accurate results for at least about 60% of queries for one or more benchmarks such as SPIDER or WikiSQL. Numerous other arrangements achieving enhanced accuracy using the disclosed techniques are possible.

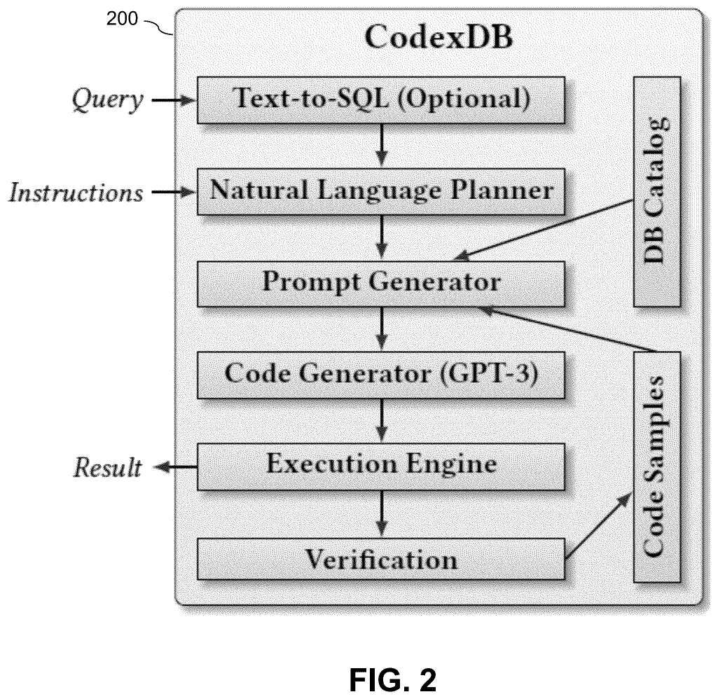

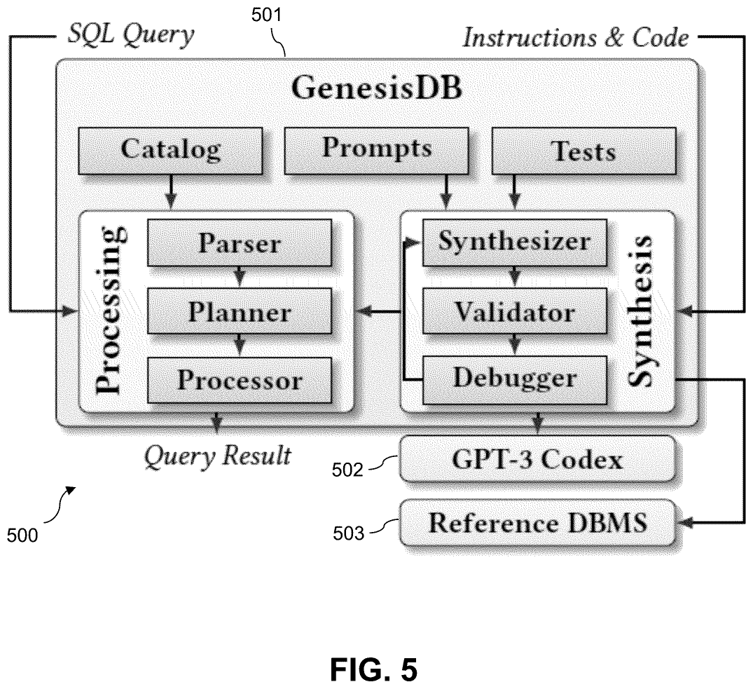

Additional details regarding illustrative embodiments will now be described with reference to FIGS. 2 through 14. One illustrative embodiment, referred to herein as CodexDB, will be described below in conjunction with FIGS. 2 through 4. Another illustrative embodiment, referred to herein as GenesisDB, will then be described in conjunction with FIGS. 5 through 14. These embodiments, like others referred to herein, are presented by way of illustrative example only, and the various features and functionality thereof should not be viewed as in any way limiting on the scope of the present disclosure.

CodexDB is an SQL processing engine whose internals can be customized via natural language instructions. CodexDB is based on OpenAI's GPT-3 Codex model which translates text into code. It is a framework built on top of GPT-3 Codex that decomposes complex SQL queries into a series of simple processing steps, described in natural language. Processing steps are enriched with user-provided instructions and descriptions of database properties. GPT-3 Codex translates the resulting text into query processing code. An illustrative embodiment of CodexDB is able to generate correct code for a majority of queries of the WikiSQL benchmark and can be customized in various ways, as disclosed herein.

Modifying a database management system under conventional practice is a difficult process. Systems such as Postgres feature millions of code lines. Understanding and changing that code requires expert knowledge in databases on top of advanced coding skills. This prevents all but the most experienced developers from creating customized versions.

Such drawbacks of conventional practice are addressed herein by CodexDB, a novel database management system that can be customized without expert developer skills. Users specify natural language instructions, along with their queries, which influences code generated for query processing. CodexDB illustratively utilizes, as a component thereof, OpenAI's GPT-3 Codex model. Codex is a large neural network that translates natural language instructions into code.

CodexDB and other embodiments disclosed herein can be utilized in a wide range of different applications. The following are some examples that illustrate a number of possible use cases.

Example 1. A developer wants to benchmark different data processing frameworks (e.g., Pandas and Vaex in Python or Table-saw and Morpheus in Java) on a specific SQL workload and hardware platform. Traditionally, doing so requires either modifying an existing database management system or writing query-specific code from scratch. With CodexDB, that developer specifies queries, together with natural language instruction such as “Use pandas library.” While CodexDB may not succeed at generating code for each workload query, obtaining performance results for a subset can guide subsequent development efforts. Also, generated code can be manually validated and reused in case of recurrent queries.

Example 2. A novice database user wants to gain a deeper understanding of how database management systems work. To that purpose, the user would like to generate customized output after each processing step (e.g., summarizing steps performed and showing a small sample of intermediate results). Integrating such changes into traditional systems is beyond the user's capabilities. With CodexDB, the user specifies natural language queries (which, internally, are translated into SQL), together with a natural language description of desired per-step output.

CodexDB as disclosed herein accepts queries, together with natural language instructions, as input. These instructions customize the way in which queries are executed. CodexDB generates code to process queries while complying with additional instructions.

Although a possible alternative approach is to submit queries and instructions directly to GPT-3 for code generation, such an approach generally does not work well.

Instead, CodexDB adapts techniques from classical query planning. It decomposes complex SQL queries into sequences of simple processing steps. In contrast to prior work, those steps are formulated in natural language using corresponding text templates. Finally, automatically generated plan steps are interleaved with user-provided instructions. The resulting text is enriched with information about the database schema and physical layout. The final text is submitted to GPT-3 Codex (as a so-called “prompt”). Using this approach as a starting point, CodexDB generates code for sample queries in a training step. The resulting code samples can be integrated into prompts generated at run time to increase the chances of success. An early prototype of CodexDB generates correct code in a majority of cases for a popular text-to-SQL bench-mark. Also, it is able to customize generated code using simple instructions, inspired by the use cases outlined before.

CodexDB therefore provides an analytical SQL engine that can be customized via natural language instructions. CodexDB is enabled by recent advances in the domain of natural language processing. Those advances have been fueled by two key ideas: a novel neural network architecture, the transformer, and new training paradigms, implementing the idea of transfer learning. The transformer is a dominant architecture in the domain of language processing. Among other advantages, it lends itself better to parallelization than prior methods. This has, in part, enabled the creation of very large, pre-trained language models. Such models are pre-trained on tasks for which large amounts of training data are easily available, e.g. predicting the next word in text snippets. While pre-training is very expensive, the resulting models can be easily specialized for new tasks via different methods. Fine-tuning describes a process in which pre-trained models are used as a starting point for further training on more specialized tasks (reducing the amount of training samples and computational overheads by orders of magnitude via pre-training). Until recently, fine-tuning has been the primary method of exploiting pre-trained language models. The latest generation of pre-trained models, most notably OpenAI's GPT-3, unlocks new possibilities. It turns out that sufficiently large models can oftentimes solve new tasks without specialized training (“zero-shot learning”), based on inputs describing the task in natural language alone. Precision increases if the input integrates few (i.e., typically less than ten) examples pairing tasks of the same type with solutions (“few-shot learning”). This method is used by CodexDB, although alternative techniques can be used. Another development utilized in CodexDB is the emergence of the Codex variant of GPT-3. The primary difference between GPT-3 Codex and the original GPT-3 model lies in the data used for pre-training. GPT-3 Codex is trained using code and technical documentation. This results in a model whose primary use case is the translation of natural language commands into code.

CodexDB builds on prior work on natural language interfaces in the database community. Previously, the focus was on “democratizing access to data,” i.e. enabling lay users to work with database systems. CodexDB goes one step further by “democratizing” the design of database system internals. The goal in some embodiments is to enable lay users to change system behavior to a degree that goes beyond the configuration scope of traditional database systems (as well as making such changes easier for more advanced users).

CodexDB also builds on prior work exploiting machine learning and specifically transformers in the context of database systems. It connects broadly to prior work by using GPT-3 for program synthesis. It differs by its focus on customizable SQL query processing. Prior work on code generation for query processing cannot integrate natural language instructions.

FIG. 2 shows an example AI system 200 implementing CodexDB in an illustrative embodiment. Users enter a query as well as natural language instructions, influencing the code generated for query processing. The query is formulated either in SQL or in natural language. In the latter case, the query is first translated into an SQL query via text-to-SQL methods.

The SQL query and natural language instructions form the input to the query planner, illustrated in the figure as a natural language planner. This planner differs from prior query planners by its output format. As the plan is translated into code by GPT-3 in the following steps, the plan is formulated as a sequence of natural language steps. User-provided natural language instructions are included as steps in such plans.

More precisely, the planner treats the nodes in a query tree in post-order. Each node is translated into a processing step, formulated in natural language. To do so, the planner uses text templates that are associated with specific node types. Table 1 shows example templates (T(X) and T(Y) denote the text representation of expressions X and Y respectively). As plan steps are numbered, intermediate results are referred to via the number of the step generating them. The last step in the plan instructs GPT-3 to write the query result into a file at a specified location.

TABLE 1
Text templates used during planning.

| Pattern | Text Template |
|---|---|
| X = Y | Check if T(X) equals T(Y) |
| from X where Y | Filter T(X) using T(Y) |
| X as Y | T(X) (aka T(Y)) |
| select X from Y | Create table with columns T(X) from T(Y) |

CodexDB in the present embodiment illustratively allows users to specify two types of instructions: instructions that refer to the plan execution as a whole (e.g., instructions on which libraries to use for processing) as well as instructions that are executed after each step (e.g., instructions determining customized logging output). Instructions of the former type are pre-pended to the template-based processing steps (i.e., they become the first plan step) while instructions of the latter type are inserted after each processing step (i.e., the number of plan steps doubles). Other embodiments can be configured to allow users to specify additional or alternative types of instructions. It should be noted that that, in the present embodiment, the planner does not perform any cost-based or heuristic optimization, although such functionality can be included in other embodiments.

Code generation is initiated by submitting a prompt to GPT-3 for completion. This prompt represents the start of a program that GPT-3 Codex tries to finish. The prompt integrates details about the data in the database, extracted from the database catalog, including the names of tables and their columns, as well as a path to the corresponding files. This description is generated using a simple text template with placeholders for column and table names. Also, the prompt integrates the aforementioned plan steps. The prompt is passed on to GPT-3 which answers with a piece of code. CodexDB tries to execute the code, and to read the generated query result. If the code does not execute (or if it does not generate a result file), CodexDB executes up to a configurable number of retries. With each retry, the “temperature” (a Codex parameter determining the degree of randomness in code generation) is increased to enable new solutions. If successful, the result is returned to the user.

CodexDB can be used in a zero-shot setting (i.e., it generates code with instructions not seen before). Alternatively, it executes a training phase before run time with fixed instructions. The purpose of training is to generate a library of code samples, generated using the target instructions. During training, CodexDB uses sample queries for which the query result is known. It retries code generation until the query result matches the known one (or until it reaches the maximal number of retries). At run time, a specified number of samples is randomly selected from that library and included into the prompt. Having examples in the prompt (“few-shot learning”) increases the success probability, as described elsewhere herein.

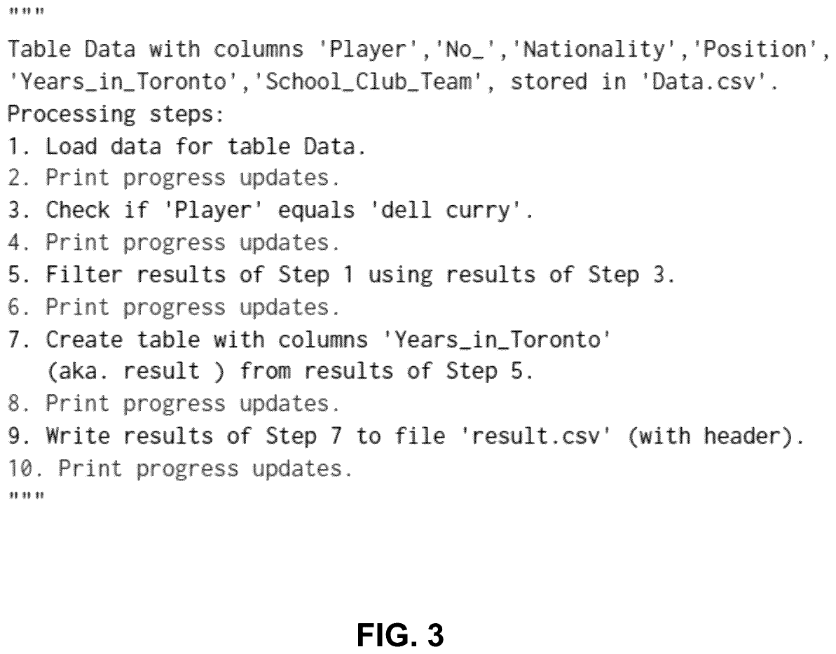

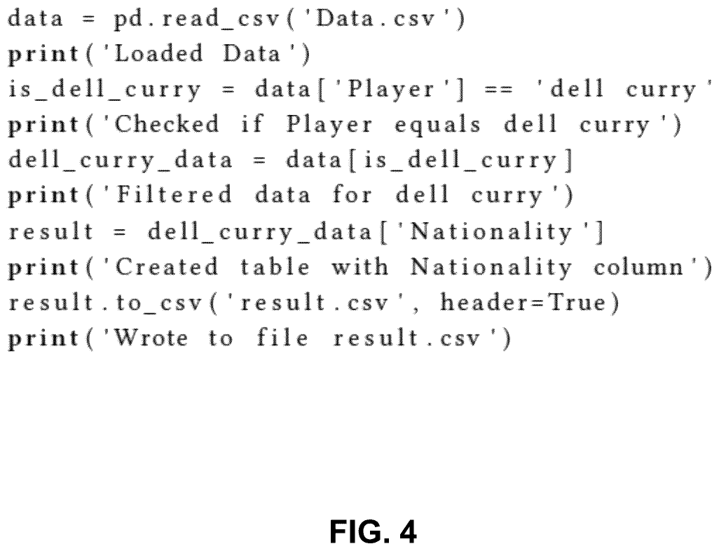

An additional example use case utilizing CodexDB will now be described with reference to FIGS. 3 and 4.

Example 3. Consider the query Select “Years_in_Toronto” as Result from Data where “Player”=‘dell curry’ from the WikiSQL benchmark. Assume a user enters this query, together with the per-step instructions “Print progress updates.”

FIG. 3 shows an example prompt for code generation integrating a description of the database, processing steps, and natural language instructions. More particularly, the prompt for this query interleaves automatically generated processing steps with user instructions and providing context on the database schema.

FIG. 4 shows code generated by GPT-3 in response to prompt from FIG. 3. It should be noted that the code was shortened for readability by removing empty lines and comments. The generated code processes the query and writes the result into a file. While doing so, it prints out progress updates summarizing steps performed.

A number of experiments were performed on an example implementation of the above-described CodexDB embodiment. The goal of the experiments was threefold. First, to verify that CodexDB generates correct code in most cases. Second, to evaluate the degree to which code can be customized via natural language instructions. Third, to compare CodexDB to other baselines.

All experiments were executed on an AWS EC2 instance of type t2.xlarge with 16 GB of RAM, four virtual CPUs, and 800 GB of EBS storage. The instance uses Amazon's Deep Learning AMI (Version 53) and runs Ubuntu 18.04. CodexDB is implemented in Python 3 and accesses OpenAI's GPT-3 Codex model via OpenAI's Python API. The experiments use the “Cushman” and “Davinci” versions of Codex with an estimated parameter count of 6.7 billion and 175 billion parameters respectively. The generated code is in Python, the language both models are most capable in.

The following experiments compare CodexDB to baselines that try translating natural language queries directly to code. This is the most direct method of using GPT-3, making the comparison interesting. Doing so requires a text-to-SQL benchmark that features natural language questions, along with corresponding queries. We consider a subset of the WikiSQL benchmark, a popular benchmark featuring over 80,000 queries with examples. The experiments only consider up to the first hundred queries as treating all queries is prohibitively expensive, in that at the time of the experiments, OpenAI Codex was only available to beta testers and its access was subject to a rate limit of 20 requests per minute. The data on which queries operate is stored in the .csv format.

The experiments evaluating CodexDB focus on the key step of translating an SQL query into code, possibly with additional natural language instructions. Translating natural language questions into SQL queries is a well-studied problem. Corresponding results for the WikiSQL benchmark are available with recent methods achieving a precision of over 90%. We consider a test case (characterized by a natural language query with associated data) as “solved” if the generated program is executable and generates the correct result. This proxy for correctness is often used to evaluate natural language query interfaces. A subset of generated programs was manually validated as well. Unless noted otherwise, CodexDB retries generation of a program once if the first generated program is not executable. If the first program executes but generates an incorrect result, the corresponding test case is not solved. CodexDB uses a temperature of zero for the first try and increases the temperature (determining the degree of randomization during code generation) by an amount determined by the formula 0.5/N, where N is the maximal number of allowed tries (typically two).

To test customization, we consider six natural language instructions. Three of them focus on processing methods by instructing CodexDB to use specific libraries: “Use pandas library,” “Use vaex library,” and “Use datatable library.” The other three instruct CodexDB to generate specific logging output after each processing step: “Print ‘Done,’ “Print intermediate results,” and “Print progress updates.” The first three instructions are added once as first plan step. The last three are added after each step of the initial plan.

One experiment compared different prompt generation methods (on 100 queries from the WikiSQL test set). “CodexDB Prompt” refers to prompts generated by CodexDB (integrating, in particular, natural language query plans). “Question Prompt” and “Query Prompt” integrate the same description of the data source as CodexDB (i.e., table and column names) but replace the natural language query plan by the natural language question or the correct SQL query respectively. It was found that the prompts of CodexDB, enriched by query plans, are necessary to generate correct code. The Davinci model (which features most parameters) solves significantly more test cases than the Cushman version. On the other side, average generation times (seven seconds versus two seconds) are higher for Davinci.

For this experiment, a success rate of 22% was found without prior training. Language models are often fine-tuned to increase performance for specific tasks. This option is not yet available for the Codex series of GPT-3. Instead, we consider few-shot scenarios in the following. Here, examples with solutions are integrated as part of the prompt.

A preparation run was performed, using 50 queries from the WikiSQL training set and the Davinci model. As training is executed before run time, up to ten tries are allowed. Furthermore, it is assumed that solutions for training samples are available, allowing to stop code generation only if the execution result is correct (as opposed to using the first executable code). The experiment determined solved test cases as a function of the (maximal) number of tries. Training took between 1510 seconds (when instructed to use the pandas library) and 8,300 seconds (with instructions “print intermediate results”). Given enough tries and results to compare to, CodexDB solves 80% of test cases without additional instructions.

With regard to number of test cases solved (out of 100 queries from the WikiSQL test set, i.e. no overlap with pre-generated samples) as a function of the number of samples included in the prompt, comparisons were done for the previously introduced prompt styles. It was found that performance improves significantly (e.g., from around 20 to around 80% for Davinci) when adding samples. Adding samples decreases the gap between CodexDB's and other prompts. Still, the CodexDB prompt performs best except for four samples and the Cushman model. The reason is the slightly longer prompts of CodexDB (featuring query plans) that exceed the maximum input size for the Cushman model for 67 test cases. Davinci supports larger inputs and does not suffer from this problem. Unless noted otherwise, the remaining experiments use two samples and the Davinci model (the configuration leading to maximal performance above).

Customization was tested by adding the previously-described instructions, to determine the number of test cases solved with different instructions. In most cases, adding more instructions tends to decrease success ratio for the largest model. Interestingly, the impact varies across instructions. In particular, asking CodexDB to use the pandas library slightly increases performance. This seems reasonable as the pandas library is popular (i.e., the training set of GPT-3 Codex likely includes various example codes) and supports operations similar to SQL operators. Manual analysis of the first 20 programs generating the correct result shows that they are indeed correct. Table 2 reports statistics on the size of generated code (and on the size of the corresponding SQL queries), measured in characters, and only considering executable programs. The average size of code generated by CodexDB is larger by up to one order of magnitude, compared to SQL queries. This illustrates the difficulty of the task. Adding instructions on logging increases code size (due to print statements after processing steps).

TABLE 2
Code length in characters for
different languages and instructions.

| Language | Instructions | Min | Median | Max |
|---|---|---|---|---|
| SQL | — | 42 | 77 | 227 |
| Python | — | 276 | 545 | 1110 |
| | Use pandas library | 284 | 438.5 | 782 |
| Use vaex library | 355 | 637 | 1018 | |
| Use datatable library | 307 | 437 | 848 | |
| Print “Done” | 390 | 724 | 1388 | |
| Print intermediate results | 458 | 875 | 1734 | |
| Print progress updates | 585 | 836 | 1458 | |

We also examined whether additional instructions are reflected in the generated programs, in terms of the number of generated programs (out of 100) that import certain libraries. Without specific instructions, 34% of generated programs import the “csv” library while 66% import pandas. Incorporating instructions to use pandas, vaex, or datatable into the prompt ensures that each generated programs imports the associated library. In some cases, in particular for vaex, programs import multiple libraries (both, csv and pandas). Manual inspection of the generated code reveals that some of those programs contain redundancy (e.g., by importing data using vaex, then transforming into pandas data frames). While this subset of programs formally satisfies the instructions (they import, i.e. “use,” the corresponding library), they do not entirely reflect its spirit.

Execution time measurements were made for programs generated with different instructions for the ten first queries. The data sets of the WikiSQL benchmark are too small for meaningful performance measurements. Hence, data were scaled by factor 1,000 and by factor 1,000,000 (by simply duplicating rows). The resulting data sets have an average size of 1.2 GB and 15 million rows. Table 3 reports total execution time for all of the aforementioned queries for which correct programs were generated for all possible instructions.

TABLE 3
Total run time for queries solved by all baselines.

| | Time (s) | |
|---|---|---|
| Baseline | SF: 1K | SF: 1M |
| CodexDB: - | 3 | 196 |
| CodexDB: Use pandas library | 3 | 119 |
| CodexDB: Use vaex library | 12 | 240 |
| CodexDB: Use datatable library | 2 | 51 |
| DBMS | 1 | 368 |

Clearly, instructing CodexDB to use different libraries has significant impact on performance. This indicates that the generated code is fundamentally different. Finally, time measurements are provided for a traditional, widely used, database management system. To ensure a fair comparison, time measurements include time for loading data from disk, processing the query, and writing the result back to disk (the generated code implements the same tasks). While performance is not the primary goal of CodexDB, the generated code is reasonably efficient.

With regard to logging-related instructions, it was determined how many out of 100 generated programs contain certain types of print commands, distinguished by the operand. This involved considering presence of any print commands, commands printing out “Done,” commands printing hard-coded strings, and commands printing out variables. Without further instructions, only 2% of generated programs contain any print statements. This ratio increases to 100% for any of the logging-related instructions. Instructing CodexDB to print “Done” after each step is reflected by the presence of corresponding print commands in each program. Instructing CodexDB to print intermediate results ensures that each generated program prints out variables. Requiring progress updates leads to programs printing out hard-coded strings in all (100%) and printing out variables in some (13%) cases. Note that this instruction leaves room for interpretation (as the form of progress updates is not specified). Manual inspection reveals that most generated code includes print commands after each step, outlining the action performed at a high level of abstraction, as illustrated in the previously-described example of FIG. 4.

CodexDB advantageously enables far-ranging customization via natural language commands, and generates correct code in most but not in all cases (e.g., up to 81% of queries are solved, depending on scenario and model). It should be noted that customizing code via natural language instructions using CodexDB works but sometimes in unexpected ways. For instance, given instructions to use specific libraries, CodexDB always imports (“uses”) them indeed. However, in a minority of cases, imported libraries are not ultimately “used” for processing query steps. This motivates stronger mechanisms allowing users to enforce a specific interpretation of their natural language input.

The natural language query planner in the above-described illustrative embodiment of CodexDB does not use cost-based optimization. This is acceptable for the simple queries of the WikiSQL benchmark. To handle complex queries with many joins, other embodiments can be configured to integrate optimization according to cost models (e.g., based on the number of tuples processed) that have been shown to work quite well across different physical operator implementations. Additionally or alternatively, machine learning can be used to optimize generated query plans for specific workloads.

As indicated previously, another illustrative embodiment, referred to herein as GenesisDB, will now be described in conjunction with FIGS. 5 through 14.

GenesisDB uses generative AI to synthesize customized operator implementations for SQL processing. Users customize GenesisDB by providing natural language instructions, describing desired behavior, as well as optional operator code samples. For instance, this enables lay users to obtain customized output for debugging, non-standard progress updates during processing, or links to SQL tutorials related to operators in the current query plan. Advanced users can generate engines that use customized data structures or processing methods.

Based on the GPT-3 Codex model, GenesisDB provides a framework that controls code synthesis, optimally schedules test cases, and automatically detects and fixes bugs by re-synthesizing specific operators. Its run time component decomposes complex SQL queries, including all queries of the TPC-H benchmark, into processing steps that are realized by custom operators. The experiments show that GenesisDB is able to generate custom code for a majority of operators in a variety of scenarios (while automatically switching to default implementations for remaining ones).

Database management systems typically use a code base that evolves slowly over time, supported by large teams of software developers. End users may still influence system behavior via tuning knobs. However, the scope of such modifications is limited and insufficient for the examples outlined next.

Example 4. A user, trying to formulate a complex SQL query, would like to add custom SQL debugging support. For instance, this may take the form of customized output, including input/output samples, printed after each operation in the query plan.

Example 5. A developer wants to integrate SQL processing into a Python application that uses specialized in-memory data structures. To avoid conversion overheads and external dependencies, the developer would like to generate custom implementations of relational operators that are tailored to existing data structures.

Example 6. A database vendor would like to explore different types of progress updates while data is being processed. This can take the form, e.g., of a progress bar or of notifications detailing the amount of data processed at certain time intervals. The vendor would like to test various different variants in a user study before fully implementing the most popular version.

Example 7. The teacher of an introductory database class would like to create a specialized processing engine that generates educative content on used operators while processing. This output could take the form of operator descriptions, links to associated SQL tutorials or book chapters, or information on the complexity of each operator as it is processing.

Existing systems are typically unable to support all of the aforementioned specializations via parameter settings. Hence, supporting the example scenarios requires code changes of existing systems or implementing a new system from scratch. Such changes are beyond the capabilities of lay users without significant expertise in coding and databases. Even for experienced developers, some of the aforementioned changes may represent significant endeavors that consume large amounts of time. Instead, GenesisDB leverages generative AI to construct a customized code base according to user specifications. In many cases, specifying instructions as a short natural language sentence is sufficient to customize large parts of the engine. Experienced users may additionally provide code samples, increasing the success rate of automated code generation further.

The enabling technology of GenesisDB are large language models (LLMs) for code generation, illustratively based on the transformer architecture. This architecture, together with pre-training approaches that leverage large amounts of unlabeled samples, has recently led to fundamental advances in the domain of natural and formal language processing. The newest generation of such models is often used without task-specific training, merely by specifying generation tasks as part of the input text (the so-called “prompt”) while optionally providing few solution samples. This is the approach taken by the present embodiment of GenesisDB, in that it employs the GPT-3 Codex model, a large language model specialized for code generation, to synthesize custom code implementing relational operators. Other types of generative transformers, Bidirectional Encoder Representations from Transformers (BERT) models, or other transformer-based language models, as well as combinations of these and/or other models, can be used in other embodiments.

Large language models alone are however unable to generate entire SQL processing engines. Their scope, in terms of the number of tokens read and generated during a single invocation, is intrinsically limited. Also, generated code is often incorrect and needs to be validated and, possibly, re-generated multiple times. Here, GenesisDB contributes a sophisticated framework on top of the language model that controls the code generation process.

GenesisDB incorporates a set of prompt templates that describe the desired behavior of standard operators, as well as input and output formats. These prompt templates contain placeholders that can be substituted by user instructions (in natural language), thereby enabling customization. GenesisDB uses GPT-3 Codex to synthesize code for each operator. Then, it validates implementations by a sequence of more and more complex tests. Such tests include SQL queries, processed using newly generated operator implementations as well as a reference system (e.g., Postgres) to verify result consistency. Failed test cases initiate an automated debugging approach. Here, GenesisDB analyzes dependencies between operators and test cases as well as a probabilistic model to identify likely faulty operators. Next, GenesisDB tries to re-synthesize code for those operators, varying the prompt structure as well as generation settings to obtain a variety of alternative implementations to test. Specifically, GenesisDB may use code generated previously for other operators which passes a large number of test cases (and is therefore likely to be correct) as samples directly in prompts. This increases the chance of generating better code for other operators.

At run time, GenesisDB uses traditional query planning to translate queries into sequences of operator invocations. This process does not involve code synthesis by models and is therefore fast and robust. GenesisDB translates query plans into code that references custom operator implementations. While their implementation is dynamically synthesized, their input/output signature is known a-priori. More precisely, for each operator, the name of the function implementing it as well as the names of its parameters are known a-priori. On the other side, the type of each input parameter can be influenced by user commands. Nonetheless, as GenesisDB uses a dynamically typed language for query execution, the code referencing custom operators does not require customization. Hence, GenesisDB synthesizes code only before run time. At run time, it uses a static component generating query-specific code that invokes previously synthesized operator implementations. Note that generated operator implementations can also be used outside of GenesisDB, e.g. in the context of an existing application storing data in specialized data structures.

In the experiments, GenesisDB is used to generate customized engines motivated by a variety of use cases, including the ones in Examples 4 to 7 as well as others. GenesisDB generally generates engines that support all of the TPC-H queries. It should be noted that GenesisDB in the present embodiment does not support the creation of views, but other embodiments can be configured to support the creation of views.

Given only a natural language sentence for instruction, GenesisDB is able to synthesize custom code that works correctly for a median of 78% of operators (ranging up to 93% for specific scenarios), while automatically switching to default implementations for the other operators. For instance, this enables lay users to perform fast prototyping themselves, using the resulting engines as-is with slightly limited scope or requesting implementation of the remaining operators from more experienced developers. Providing additional code samples increases success probability for expert users (who can fix remaining operators themselves with limited overheads). Also, the experiments compare GenesisDB to the previously-described CodexDB, which tries to directly generate customized code for query processing.

As described above, GenesisDB uses generative AI to customize operator implementations, based on natural language instructions and optional code samples.

The last few years have seen transformative advances in the domain of language processing, including natural as well as formal languages. These advances are due to novel neural network architectures, in particular the transformer model, as well as to the successful application of transfer learning methods in training. Transformer models, among other advantages, facilitate the creation of large models with hundreds of billions of trainable parameters. When trained on generic tasks (e.g., predicting the next token) on sufficiently large amounts of unlabeled training data, such models require little to no specialization to solve new tasks. One of the most recent applications of large transformer models are models for code synthesis. Trained on large amounts of code from repositories such as GitHub, such models complete prompts, i.e. short text documents containing partial code or natural language instructions, into fully specified code in general purpose programming languages. In certain settings, their performance is comparable to that of human developers.

GenesisDB is based on OpenAI's GPT-3 Codex model, a GPT-3 variant specialized for code generation. This is the same model powering GitHub's CoPilot, an auto-completion tool offered on the GitHub platform. Unlike CoPilot, GenesisDB is configured to generate code for relational operators that, when combined, form a complete SQL processing engine. GenesisDB features prompt templates, specialized for generating relational operators, as well as strategies needed to create a complex system from parts generated in different code synthesis steps. The size of a typical engine, generated by GenesisDB, far exceeds the code size typically generated in a single model invocation. GenesisDB relates to and expands upon CodexDB as disclosed herein. As described previously, CodexDB illustratively comprises a system configured for synthesizing code for processing SQL queries that additionally implements natural language instructions. While CodexDB synthesizes code for processing one specific SQL query, GenesisDB in some embodiments herein provides a system that can process all queries without run time code synthesis. As shown by results of the experiments described below, this approach enables GenesisDB to handle significantly more complex queries.

GenesisDB also relates to other recent applications of language models and, more broadly, machine learning in the context of database management systems. These include, for instance, prior work on natural language query interfaces, as well as approaches for entity matching, data wrangling, database auto-tuning, and data integration. Several recent publications use language models or, generally, machine learning to implement relational operators directly, leading to approximate processing. Instead, GenesisDB uses machine learning before run time to synthesize code for processing.

FIG. 5 shows an overview of an AI system 500 implementing GenesisDB in an illustrative embodiment. The AI system 500 comprises a GenesisDB framework portion 501 that interacts with GPT-3 Codex 502 and a reference database management system (DBMS) 503 as shown, although in other embodiments one or both of the components 502 and 503 may be at least partially incorporated into the GenesisDB framework portion 501.

As indicated previously, the term “AI system” as used herein is intended to be broadly construed so as to encompass these and other arrangements of components. Accordingly, various subsets of the components 501, 502 and 503 of the FIG. 5 embodiment may also be considered as respective examples of AI systems as that term is broadly used herein.

Initially, query processing will be described, followed by description of how GenesisDB synthesizes its core engine using generative AI.

With regard to query processing, the processing sub-system (at the left side of the GenesisDB framework portion 501 in FIG. 5) processes SQL queries and returns results to users. GenesisDB is an analytical SQL processing engine and supports all queries of the TPC-H benchmark. It does not support transactions in the present embodiments, but transactions may be supported in other embodiments. As described in more detail below, GenesisDB uses relational operators for processing that are synthesized according to user instructions. A GenesisDB database is illustratively represented as a directory, containing a file with SQL commands creating the corresponding schema, as well as one .csv file for each table in the database (containing the data). GenesisDB in some embodiments is designed for ultimate customizability. Storing data in the popular .csv format, widely supported by code libraries, increases the range of applicable operator implementations. At the same time, as code processing .csv files is heavily represented in the training data of current code generation models, choosing this format may facilitate synthesis.

The database catalog contains information on the database schema and file locations, extracted from the database directory. It is used to inform the query parser as well as the query planner. The present embodiment of GenesisDB uses a simple, rule-base query planner, implemented by the Apache Calcite library, although it is to be appreciated that other types of planners can be used in other embodiments. The planner generates a logical query plan, determining the sequence of operations without selecting between operator implementations. Using cost-based optimization is challenging as the implementation (and, therefore, cost function) of operators changes dynamically. Learned cost models requiring few samples may be used to facilitate this process.

The SQL processor translates logical query plans into a sequence of steps, using a set of 54 operators, shown in Table 4.

TABLE 4
Operators synthesized by GenesisDB.

| Group | Operators |
|---|---|
| Tests | CheckColumnType, CheckTableType |
| I/O | LoadTable, StoreTable |
| Basic | GetColumn, GetValue, CreateTable, GetNull, IsNull, |
| | IsEmpty, SetColumn, AddColumn, FillintColumn, |
| | FillFloatColumn, FillBoolColumn, FillStringColumn, |
| | NrRows, Map, ToInt, ToFloat, ToBool, ToString, Sub- |
| | string, Limit |
| Arithmetic | Addition, Subtraction, Multiplication, Division, |
| | Floor |
| Boolean | LessThan, GreaterThan, LessOrEqual, |
| | GreaterOrEqual, Equal, NotEqual, Case, |
| | And, Or, Not, Filter |
| Aggregates | Sum, Min, Max, Avg, Count, SumGrouped, Min- |
| | Grouped, MaxGrouped, AvgGrouped |
| Complex | Sort, InnerJoin, LeftOuterJoin, RightOuterJoin, |
| | CartesianProduct |

These operators are more fine-grained than the ones typically used in database engines (e.g., introducing separate operators for aggregation with and without grouping as well as for different join types). The goal of using relatively specialized operators is to make operator synthesis easier, reducing the number of cases that need to be handled per function. GenesisDB generates code for processing queries, combining synthesized code implementing operators with code invoking the latter to execute the query plan. All code is formulated in Python (Version 3.8), advertised by OpenAI as the language GPT-3 Codex (the model used for synthesis) is “most capable.” Clearly, this choice reflects the design priorities of GenesisDB, valuating utmost customizability over performance.

Aspects of operator synthesis will now be described. A distinguishing feature of GenesisDB, compared to prior systems, is that it re-synthesizes its operator implementations based on user instructions. These instructions are expressed in natural language (for users without technical background) and may optionally include code snippets (provided by more experienced users). These instructions may change the in-memory representation of tables, columns, or fields, as well as inject custom behavior during processing. For instance, this may include generating output that is useful for debugging or training, executing custom performance or data analysis, or writing checkpoints according to user instructions. GenesisDB generates code via prompting, i.e. by submitting small text documents describing the generation task to generative models (the present embodiment uses GPT-3 Codex) for completion. Users influence the generation process by providing substitutes for placeholders in prompt templates or custom text that is added as prefix or suffix to default prompts. Table 5 shows an overview of all the prompt components that can be influenced by users.

TABLE 5
GenesisDB accepts natural language instructions or code snippets for the
following SQL engine properties.

| Property | Semantics |
|---|---|
| Prefix | Common prompt prefix (e.g., imports) |
| Table | How to represent relations |
| Column | How to represent columns |
| Null | How to represent the SQL NULL value |
| Boolean | How to represent Boolean values |
| Integer | How to represent integer values |
| Float | How to represent float values |
| String | How to represent string values |
| Suffix | Common prompt suffix (e.g., behavior) |

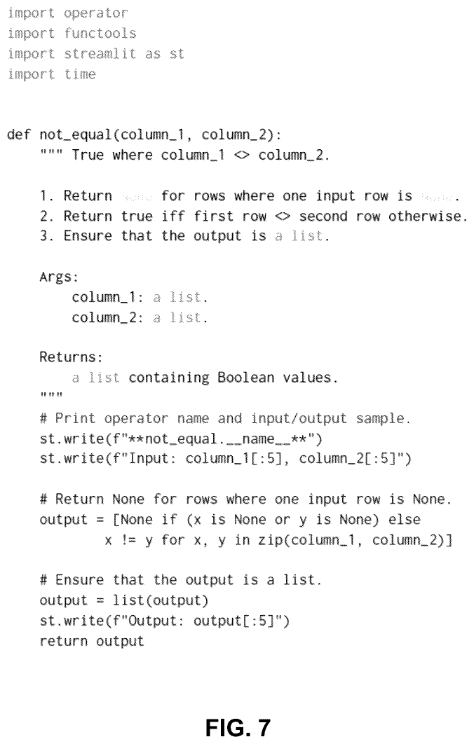

Table 6 shows example settings for the properties in Table 5, suitable to generate a simple engine that uses standard types and generates input samples for each operator (e.g., to help debugging SQL queries). This engine is synthesized in further description below (along with others). An example to be described below in conjunction with FIG. 7 shows how such properties are integrated into a prompt.

TABLE 6
Example settings to synthesize a simple SQL engine.

| Property | Value |
|---|---|
| Prefix | import functools |
| | import operator |
| | import streamlit as st |
| | import time |
| Table | a list of rows where each row is a list |
| Column | a list |
| Null | None |
| Boolean | bool |
| Integer | int |
| Float | float |
| String | str |
| Suffix | # Print operator name and input sample. |

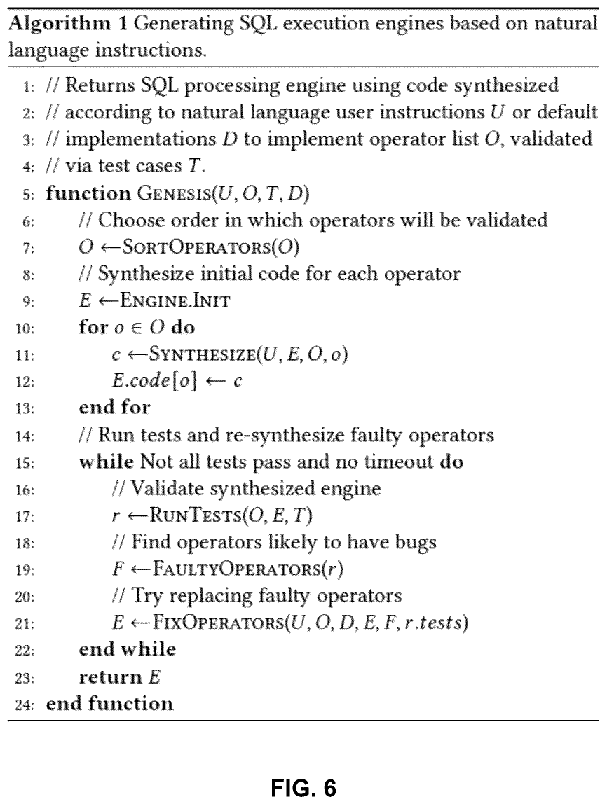

FIG. 6 shows pseudocode of an example algorithm for generating SQL execution engines based on natural language instructions in an illustrative embodiment. This example algorithm, denoted herein as Algorithm 1, implements a synthesis process as disclosed herein. Given user instructions, a list of operators to synthesize, a set of test cases to validate synthesized operators, and, optionally, default implementations for each operator, it returns a custom engine (i.e., operator implementations) that follows the input instructions. The full list of operators, as well as their semantics and function signatures, remain fixed (to enable the query processor to use them appropriately to realize query plans). If desired, synthesis may only focus on a subset of operators (while using default implementations for others). To validate generated implementations, GenesisDB uses a set of 172 test cases by default (users can easily add new test cases that are automatically used during synthesis). Test cases are either realized as SQL queries (then, GenesisDB compares query results generated by custom operators to the ones generated by a reference system) or as small code samples referencing operators (here, GenesisDB ensures that all assertions hold).

GenesisDB first sorts operators using a simple heuristic (based on the length of the associated prompt), prioritizing operators that are potentially easier to synthesize. As discussed in more detail below, operator order matters as it influences, for instance, the order in which tests are performed. Also, code synthesized for operators that are ordered earlier may be used as sample when synthesizing operators that appear later. After sorting, GenesisDB synthesizes a first version of the engine by generating one implementation for each required operator (E.code [o] denotes the implementation of operator o).

Next, GenesisDB validates generated code via test cases and tries to fix problems via re-synthesis. This process continues until the generated engines passes all test cases or until a user-defined timeout is reached. Testing via function RUNTESTS stops at the first failed test case. The result of testing is a summary, reporting passed and failed tests. GenesisDB uses that summary to identify likely faulty operators, then tries to fix them. Fixing an operator involves re-synthesizing its code, possibly with a different prompt and different synthesis settings. If this approach fails to resolve previous problems, using a limited number of tries, GenesisDB uses default operator implementations instead. Those default operators should use the same data representation as the desired target engine (in order to be compatible). They may however not implement any custom behavior requested by the user. Therefore, GenesisDB tries to minimize the number of default operators used. If default operators are not specified, GenesisDB ultimately notifies the user, hinting at operators that likely need replacement. After providing corresponding code, the synthesis process can be restarted.

As indicated above, GenesisDB synthesizes operator code using prompts. Prompts describe the synthesis task to the generative AI model (in the present embodiment, GPT-3 Codex). The description below presents the prompt generation process, followed by the synthesis process.

With regard to prompt generation, GenesisDB illustratively uses prompts following the structure depicted in Table 7.

TABLE 7
Different prompt parts with sources.

| Part | Source | Optional |
|---|---|---|
| Generic prompt prefix | User | Yes |
| Similar operator prompt | Library, User | Yes |
| Similar operator code | Synthesis | Yes |
| Operator prompt | Library, User | No |
| Generic prompt suffix | User | Yes |

Each prompt starts with a user-defined prompt prefix (which is optional). Advanced users may, for instance, use the prefix to import required libraries or to show code samples that facilitate synthesis. Next, the prompt may optionally contain samples of prior prompt completions. Those samples consist of the prompt previously provided (without duplicating the prefix, however) as well as the code generated in response to that prompt. Typically, previously generated code is only used as sample after passing one or multiple test cases, thereby increasing the chances that sample code is correct. Next, the prompt contains a code snippet that is specific to the operator to synthesize. It describes its semantics as well as the desired input and output format. This part of the prompt implements an operator-specific template, stored in a prompt library. These templates do not change from one engine to the next. However, they contain placeholders that are substituted by user-provided instructions. These placeholders define, for instance, the representation of NULL values as well as how columns and tables are represented in memory. Finally, the prompt contains an optional suffix. Here, users can specify, in natural language, specialized operator behavior such as additional input and output to generate.

FIG. 7 shows an example prompt and associated example code generated utilizing the AI system of FIG. 5 in an illustrative embodiment. More particularly, this figure shows a simple example prompt, used to generate the “NotEqual” operator, as well as the completion by GPT-3 Codex (after manually adding one line break and two empty lines to increase readability). The first four lines represent the prompt prefix and load several libraries, e.g. enabling performance measurements or visual output (via the streamlit library). The lower part of the figure illustrates the completion by GPT-3 Codex. User instructions describing the representation of columns (“a list”), NULL values (“None”), and custom behavior (“Print operator name and input/output sample.”) substitute placeholders in the prompt template.

The prompt in FIG. 7 does not contain any code samples. The operator-specific part of the prompt starts after the above-noted first four lines. FIG. 7 more particularly shows the template, instantiated by user-defined instructions (e.g., specifying that NULL values are represented as “None” values and columns as lists). The line that includes “#Print operator name and input/output sample” represents the prompt suffix. It contains a user-defined modification, requiring the operator to print its name as well as input and output samples. The remaining lines in FIG. 7 shows the completion by GPT-3 Codex. The generated code shown in this portion of the figure implements the desired input-output functionality as well as the output requested in the prompt suffix.

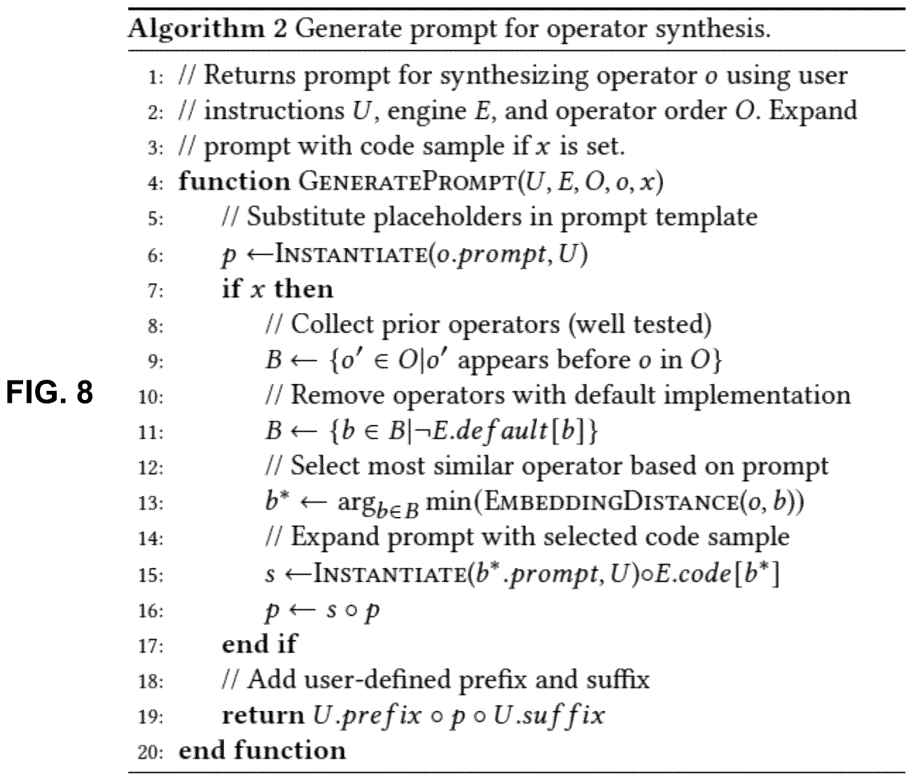

FIG. 8 shows pseudocode of an example algorithm for generating a prompt for operator synthesis in an illustrative embodiment. This example algorithm, denoted herein as Algorithm 2, implements a prompt generation process. First, the function GENERATEPROMPT instantiates the prompt template (o.prompt) by user-provided placeholders (INSTANTIATE). The input flag x determines whether to expand the prompt via code samples, obtained from prior synthesis. To maximize utility, code samples are selected from similar operators. Operator similarity is determined automatically by comparing the prompt templates. It is based on the cosine distance between the embedding vectors for the prompt templates, generated by GPT-3. GenesisDB selects as sample the operator that minimizes distance among all candidates. GenesisDB only considers operators that come before the current operator in order O. As discussed in more detail below, tests prioritize operators that appear earlier in the operator order. Hence, using earlier operators maximizes the chance that they are well tested and work correctly Furthermore, GenesisDB does not consider default operators as code samples. Default operators are used in case of an emergency, if repeated code synthesis fails to yield correct code. Such operators may not implement functionality requested by the user. Hence, GenesisDB prefers using synthesized operators as samples. Finally, the function GENERATEPROMPT adds prefix and suffix (o represents the concatenation) and returns the final prompt.

Table 8 shows three example operators with the two most similar operators, according to embedding distance.

TABLE 8
Operators ranked by prompt similarity.

| Rank | ToFloat | Avg | RightOuterJoin |
|---|---|---|---|
| 1 | ToInt | Sum | LeftOuterJoin |
| 2 | ToString | Max | InnerJoin |

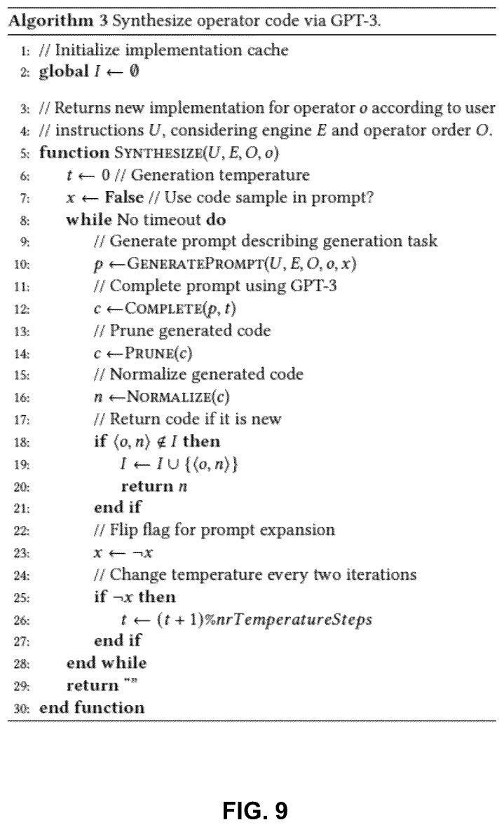

FIG. 9 shows pseudocode of an example algorithm for synthesizing operator code in an illustrative embodiment. This algorithm, denoted herein as Algorithm 3, implements a process for code synthesis. The function SYNTHESIZE of Algorithm 3 uses Algorithm 2 as a sub-function to generate prompts for synthesis. It iterates until it succeeds at generating novel code for the operator or until a timeout is reached. Global variable I contains all previously generated operator implementations. More precisely, it contains tuples of the operator and the generated code (this accounts for the unlikely case that a piece of code was generated previously but for a different operator).

GenesisDB exploits two mechanisms for generating diverse code for the same operator. First, it changes the prompt by adding (or removing) code samples. Second, it increases the so-called temperature, measuring the degree of randomness used by GPT-3 Codex during prompt completion. Variables x and t determine whether to add code samples and which temperature to use, respectively. Variable x is flipped in each iteration to enable and disable code samples. Temperature t increases until reaching a configurable number of steps (in all experiments, five temperature steps are used). Then, it is reduced to the minimum again.

After invoking GPT-3 Codex to complete the given prompt (function COMPLETE), using the given temperature, the generated code is post-processed. First, it is pruned (function PRUNE). Pruning is necessary as GPT-3 Codex tends to generate irrelevant code, after finalizing the requested operator, until the generation token limit is reached (the model allows specifying stop words but finding stop words that work in all cases has proven difficult). During pruning (its pseudocode is not shown in the figure), GenesisDB traces dependencies, starting from the function implementing the desired operator. It adds generated functions as long as they are called from the initial function. This is needed as Codex often generates code consisting of multiple connected functions to implement complex operators such as joins. In other cases, generated functions are not connected to the initial operator but implement new operators that are not required.

After pruning, generated code is normalized. The goal of normalization is to recognize cases in which generated code is only slightly different from implementations already known. For instance, normalization removes comments and empty lines. If normalized code is equivalent to code already known, it is not useful to return the newly generated code (as the new implementation cannot pass tests failed by the prior code). If normalized code is novel, it is inserted into the set of known implementations and returned as result.

As indicated previously, GenesisDB performs tests to identify faulty operator implementations. It executes tests whenever the operator code changes (e.g., due to re-synthesis). Testing continues until all test cases have passed or until the first failed test is found.

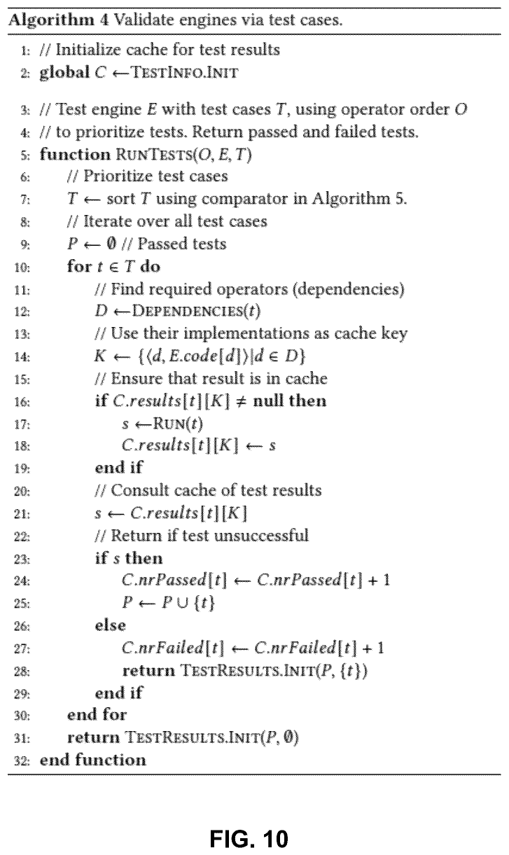

FIG. 10 shows pseudocode of an example algorithm for validating engines via test cases in an illustrative embodiment. This algorithm, denoted herein as Algorithm 4, implements a process for validation using test cases. Given (ordered) operators O, an engine E to test and test cases T, function RUNTESTS returns a record of type TESTRESULTS (its fields are described in Table 9), specifying passed and failed tests.

TABLE 9
Fields of type TestResults.

| Field | Semantics |
|---|---|
| passed | Set of passed test cases |
| failed | Set of failed test cases |
| tests | Set of all executed tests |

GenesisDB evaluates test cases in a carefully selected order, as described in more detail below, stopping at the first failure. Test cases are described either as SQL queries or as code snippets, containing assertions. In the first case, GenesisDB compares the query result, generated using synthesized operators, to the result of a reference engine. In the second case, GenesisDB executes code referencing operator implementations to ensure that all assertions hold.

Evaluating test cases can be expensive, in particular in case of SQL queries. To avoid redundant work, GenesisDB uses a cache to store previously obtained test results. This cache is represented by global variable C of type TESTINFO in Algorithm 4. Table 10 describes the fields of this type, capturing test results as well as test statistics.

TABLE 10
Fields of type Testinfo.

| Field | Semantics |
|---|---|
| results | Maps test cases to cached test results |
| nrPassed | Maps test cases to number of passed tests |
| nrFailed | Maps test cases to number of failed tests |

Field results maps test cases to their cached results (C.results [t] denotes results for test t), indexed by a cache key that captures the testing context. Test results can only be reused if the prior context is equivalent to the current one, i.e. if the test is guaranteed to produce the same result. This is not the case if the implementation of operators has changed that are referenced directly by the test. In addition, operators may call each other as sub-functions. This is possible if the implementation of one operator was used as code sample when synthesizing a second operator. In that case, GPT-3 may include calls to the first operator in the implementation of the second. This creates indirect dependencies that must be taken into account as well. Function DEPENDENCIES (its pseudocode is not shown in the figure), used in Algorithm 4, collects all direct and indirect dependencies via recursive analysis of operator code (i.e., it returns the names of all associated operators).

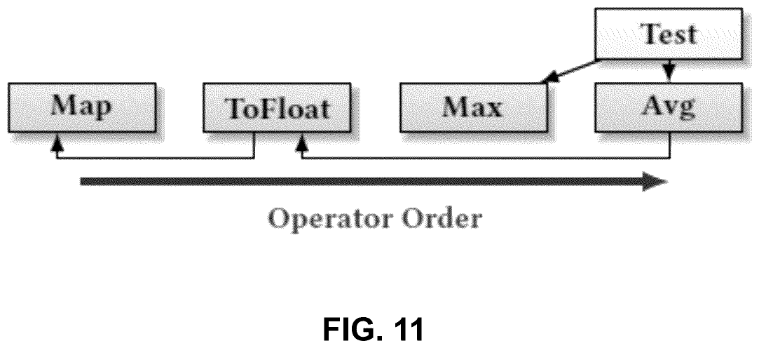

FIG. 11 shows example dependencies between tests and operators in an illustrative embodiment, including direct and indirect dependencies. More particularly, FIG. 11 shows dependencies between tests and operators: synthesized operators may depend on prior operators (in operator order) that were used as code samples during code synthesis.

The test as illustrated in the figure directly references operators Avg and Max. Operator Avg uses operator ToFloat as a sub-function which, in turn, calls operator Map. Hence, whether the test case succeeds may ultimately depend on the implementation of each operator shown in the figure. Note that dependencies between operators can only occur in inverse direction of operator order (since code of prior operators is used as sample when synthesizing later operators but not the other way round).

Given the set of relevant operators (dependencies), Algorithm 4 retrieves their code from the engine to test (line 14). The map from relevant operators to their implementations forms the cache key. If the cache contains prior entries for that key and the current test case, the prior test result is reused. Otherwise, the current test is performed. Whenever a test is performed, statistics associated with that test case are updated, depending on the result (i.e., the number of passed and failed tests).

As described elsewhere herein, evaluating tests in random order performs badly. Instead, GenesisDB sorts tests using the following principles. First, it prioritizes tests with a low chance of succeeding, based on past statistics. Doing so reduces the expected number of tests to perform (as the test procedure stops at the first failure). Second, GenesisDB focuses tests on a small set of operators first before gradually expanding that scope. More precisely, for each prefix of the operator order, GenesisDB prioritizes tests that only depend on that prefix over ones that depend on longer prefixes. This is motivated by the fact that code synthesized for prior operators may be used as sample to facilitate synthesizing later operators. Using faulty code as sample makes successful synthesis unlikely. Hence, the system applies all available tests to current operators before testing the next (as that may result in a re-synthesis of the next operator, using prior operator code as sample).

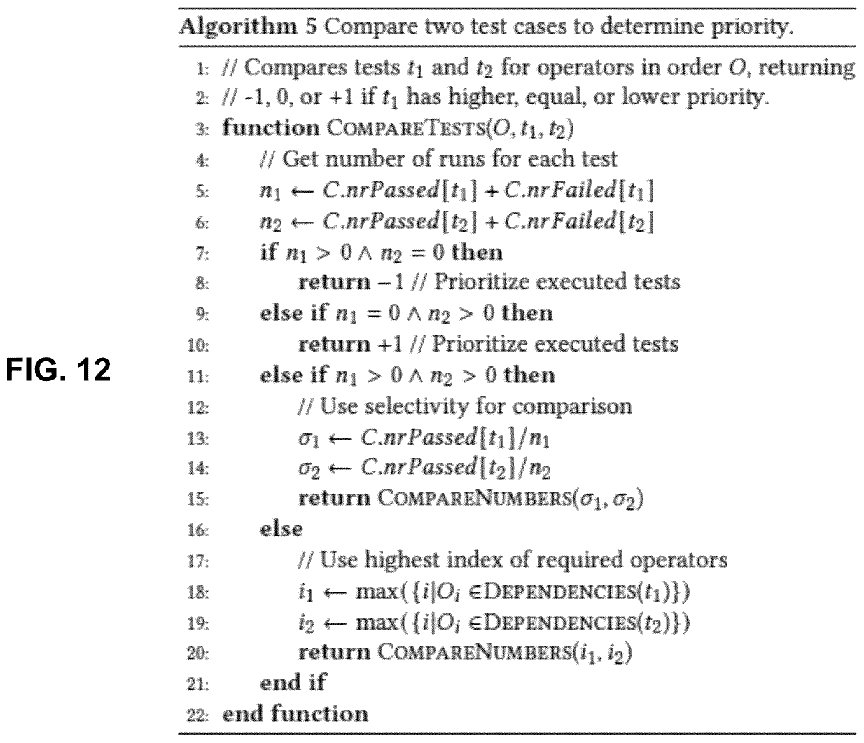

FIG. 12 shows pseudocode of an example algorithm for comparing test cases to determine priority in an illustrative embodiment. This algorithm, denoted herein as Algorithm 5, is used in line 7 of Algorithm 4, and implements a comparison function COMPARETESTS based on the above-described principles. The function prioritizes previously executed over new tests, sorts executed tests by selectivity and other tests based on their required operators. It uses COMPARENUMBERS as a sub-function, returning a comparison results for two numbers (sorting lower numbers first).

Table 11 shows tests sorted via Algorithm 5 (top to bottom).

TABLE 11
Relevant statistics to sort example tests.

| TestID | Dependencies | NrPassed | NrFailed |
|---|---|---|---|
| 1 | ToFloat, Avg | 0 | 10 |
| 2 | StoreTable, ToInt, LessThan | 2 | 6 |
| 3 | StoreTable, Sum | 0 | 0 |
| 4 | StoreTable, InnerJoin | 0 | 0 |

Test 1 is sorted before Test 2 since it is more selective (Test 1 has a selectivity of zero while Test 2 has a selectivity of 2/8=0.25). Test 2 is sorted before Test 3 as Test 3 was not yet executed. Assuming an operator order sorting StoreTable before Sum and both, StoreTable and Sum, before the InnerJoin operator, Test 3 is ordered before Test 4. Test 4 is scheduled last as it depends on the InnerJoin operator which comes late in the operator order.

Automated debugging aspects will now be further described. Failed test cases indicate incorrect operator implementations. GenesisDB tries to fix such problems by re-synthesizing code for operators.

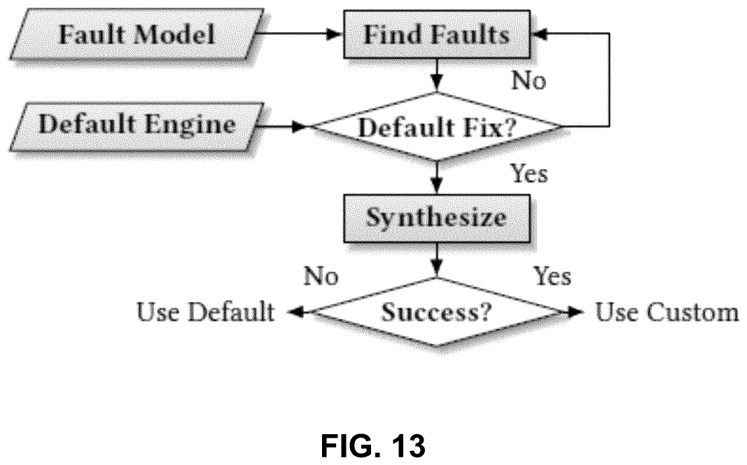

FIG. 13 illustrates an example debugging process, assuming that default operator implementations are available. More particularly, the example debugging process performs debugging utilizing a default engine. Accordingly, in this embodiment, GenesisDB identifies likely faulty operators via a probabilistic model and verifies faults using default implementations. If synthesis succeeds, custom operators replace default implementations.

First, GenesisDB applies a probabilistic model to identify operators most likely to be faulty. This model uses the set of passed and failed tests, as well as information on dependencies between operators and tests, as input. The probabilistic model is described in more detail below. Next, GenesisDB tentatively replaces synthesized code by default implementations, thereby narrowing down the set of possible faults. If replacing an operator by the default implementation increases the number of test cases passed, GenesisDB tries to re-synthesize that operator according to user instructions (using randomization to avoid re-generating problematic code twice). If successful, the re-synthesized code replaces the prior one. Otherwise, the default implementation is used.

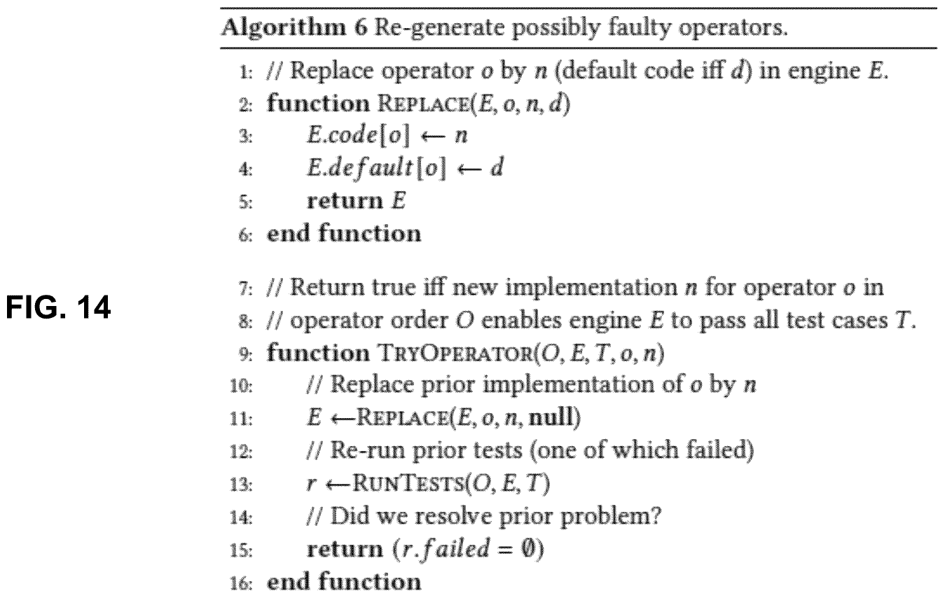

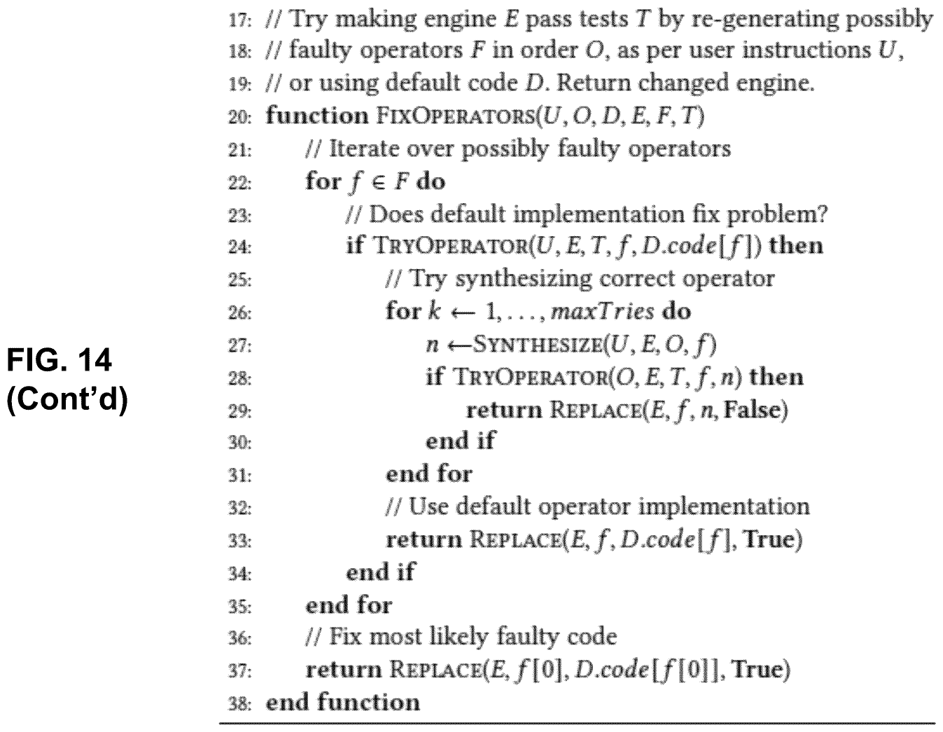

FIG. 14 shows pseudocode of an example algorithm for re-generating possibly faulty operators in an illustrative embodiment. This algorithm, denoted herein as Algorithm 6, implements a faulty operator re-generation process. Given user instructions for operator synthesis, U, operators O with default implementations D, engine E to fix and a set of possibly faulty operators F (identified using the probabilistic model, discussed next), function FIXOPERATORS tries to change the engine in order to make it pass tests T. Those tests integrate all tests executed in the previous invocation of RUNTESTS (as described above), i.e. all passed tests and a single failed test. If all of them can be passed by changing the operator code, the resulting engine is strictly preferable over the prior version. The result of the function is an updated engine. Function FIXOPERATORS uses two sub-functions: REPLACE and TRYOPERATOR. The former function simply replaces an operator implementation, as well as marking it either as default implementation or not. Marking default implementations is important to avoid using them as code samples during synthesis, as described previously. Function TRYOPERATOR verifies whether a specific code change yields the desired result (all test cases pass). Function FIXOPERATORS uses that function first to determine whether using a default implementation for a specific operator solves the problem. Note that some problems cannot be fixed by replacing a single operator but require multiple changes. However, test cases (e.g., complex SQL queries) may depend on many operators, making an exploration of all subsets of possibly faulty operator expensive. Replacing code for all but the current operator by defaults fails to uncover errors due to the interplay between multiple, partially correct operators (e.g., default operators may automatically convert input data to a desired representation, making up for a synthesized operator failing to produce the correct output format). Hence, GenesisDB deliberately limits the scope of debugging to reduce overheads. If debugging or re-synthesis fail, the operator most likely to be incorrect is replaced by its default implementation. As default implementations are never re-visited during debugging, this approach will eventually make the engine pass all test cases even in a worst case (after replacing all operators by default implementations).

Finally, note that Algorithm 6 covers the scenario in which default operators are available. If this is not the case, the algorithm simplifies to trying to re-synthesize operators in decreasing order of fault probability. If this approach does not succeed, GenesisDB notifies the user and asks for code to replace the operator with the highest fault probability.

GenesisDB uses a probabilistic model to identify possibly faulty operators (represented by the call to function FAULTYOPERATORS in Algorithm 1). It is based on the following assumptions. While those assumptions are simplifying, the experiments described below show that the resulting model is effective.

Assumption 1. The probability of generating incorrect code is identical and independent across different operators and tries.

Assumption 2. The probability of passing different test cases is identical and independent across tests.

Assumption 3. Only one operator implementation is incorrect.

Assumption 4. Default implementations are always correct.

Due to Assumption 4, the model excludes default operator implementations from further consideration. Let [symbol] ₒ denote the event that only faulty implementations are available for operator o (i.e., re-synthesis is required). Also, denote by [symbol] _{T} the results obtained for tests T. Using the Bayes formula, the probability of [symbol] ₒ can be expressed as follows:

$$Pr ( {ℱ}_{o} \vert {ℛ}_{T} ) = \frac{Pr ( {ℛ}_{T} \vert {ℱ}_{o} ) \cdot Pr ( {ℱ}_{o} )}{Pr ( {ℛ}_{T} )}$$

Among the components that appear on the right-hand side of this formula, only Pr( [symbol] _{T}| [symbol] ₒ) and Pr( [symbol] ₒ) depend on the operator o (while Pr( [symbol] _{T}) can be neglected when ranking operators). Predicate L(o,t) represents a link between test t and operator o (i.e., the test depends on operator o, either directly or indirectly). The probabilistic model only ranks operators that are linked to the last (failed) test. Now, Pr( [symbol] _{T}| [symbol] ₒ)=Pr(∧_{t∈T} [symbol] ₒ| [symbol] ₒ) can be rewritten as Π_{t∈T}Pr( [symbol] ₒ| [symbol] ₒ) (exploiting Assumption 2) and as ℏ_{t∈T:L(o,t)}Pr( [symbol] ₒ| [symbol] ₒ). The latter transformation exploits the fact that a faulty operator does not influence tests that do not depend on it. Also, assuming a single incorrect operator (Assumption 3), the event [symbol] ₒ implies that all other operator implementations are correct. Hence, the associated tests must succeed.

Tests with a faulty operator may still succeed with a certain probability (in practice, it often takes several tests to detect incorrect implementations). Denoting this probability by α while assuming identical and independent tests (Assumption 2) implies Pr( [symbol] _{T}| [symbol] ₒ)=α^{|{t∈T|L(o,t)}|-1}. (1−α). Finally, due to Assumption 1, the probability of mₒ failed synthesis tries for operator o can be written as Pr( [symbol] ₒ)=(1−β)^{m}^{ₒ} no (using β to represent the probability of synthesizing a correct operator).

While simplifying, the model integrates two intuitive principles. First, for re-synthesis, it de-prioritizes operators for which repeated re-synthesis did not resolve failed tests in the past. Second, it deprioritizes operators involved in many passed test cases.

The following description introduces the experimental setup, reports on the synthesis results, and compares GenesisDB to baselines.

The experiments are executed on a t2.2xlarge EC2 instance, featuring eight virtual CPUs, 32 GB of main memory, and 500 GB of EBS storage. The instance is running Ubuntu and GenesisDB uses Python 3.8 to execute queries. Postgres 10.22 is used to generate reference results for all test cases. All test queries are executed on a TPC-H database with a low scaling factor of 0.01 to speed up test evaluation (other results are reported for scaling factor one). GenesisDB uses GPT-3 Codex for code synthesis. More precisely, it uses the Davinci 2 variant (which was the most powerful version at the time the experiments were performed). GenesisDB retries operator synthesis five times (constant maxTries in Algorithm 6) and uses α=0.14, β=0.97 for the probabilistic model (based on the results of a micro-benchmark, synthesizing a simple join operator). It uses 172 test cases for validation, including all TPC-H queries, executed on a TPC-H database with scaling factor 0.01.

The experiments consider a variety of customization scenarios. These are inspired by the examples in the introduction as well as by other use cases. Unless noted otherwise, the settings from Table 6 are used with the exception of the prompt suffix. The suffix describes non-standard behavior in natural language and is replaced by different sentences to obtain different behavior. Table 12 describes several engines synthesized in the following experiments, along with their short names (used in the following plots) and the instructions used in the prompt suffix. The requested changes range from output for SQL debugging over the addition of checkpoints (e.g., to support recovery in case of failure during long-running queries) up to visualization of operator input data, allowing simple skew analysis.

TABLE 12
Miscellaneous engines and associated instructions.

| Name | Per-Operator Instructions (Suffix) |
|---|---|
| education | Print explanation of this operation in at most three sentences. |
| progress | Print progress updates after each 10% of input data processed. |
| debugging | Print operator name and input sample. |
| performance | Print operator name and execution time of each step. |
| checkpoint | Write input data to checkpoint on disk (as .csv file). |
| visualization | Visualize the number of distinct values in each input column as plot. |

Table 13 shows additional instructions, requesting highly specific output while processing. For instance, the instructions request code that prints information on the worst-case complexity of the current operator, links to Wikipedia articles, book chapters, or SQL tutorials that relate to the current operation, or particularly detailed operator descriptions. Such output could be useful, e.g., in a system used for experiments by students of an introductory database course. Primarily, the test cases are meant to test GenesisDB's limit in terms of specificity of instructions as well as its capability to use knowledge in its pre-training data (e.g., links) for synthesis.

TABLE 13
Education variants and associated instructions.

| Name | Per-Operator Instructions (Suffix) |
|---|---|
| Complexity | Print operator name and its worst-case complexity |
| Book | Print number of most relevant chapter in “Database |
| | Management Systems” by Ramakrishnan and Gehrke |
| Long | Print description of operator with at least four sentences. |
| Tutorial | Print link to SQL tutorial describing this operator. |
| Wikipedia | Print Wikipedia URL associated with this operator. |

When processing all of the aforementioned scenarios, a default engine is used that was synthesized without suffix (i.e., default operators do not implement any behavior beyond their core functionality). Unless noted otherwise, all of the following experiments assume a zero-shot setup (i.e., no operator code samples are provided to GenesisDB). For experiments marked as one-shot setup, one sample operator is provided as part of the prompt prefix. This sample operator increments all values in a column by one. It is not used during query processing.

Finally, several customization scenarios vary the way data is represented or processed. For those scenarios, multiple properties are changed, compared to Table 6. Table 14 shows the settings for “arrow,” an engine that uses Appache Arrow tables as in-memory data format. The full descriptions of two other engines, “parallel” and “bytecode,” are omitted due to space restrictions. The former (“parallel”) parallelizes operators via the multiprocessing library. The latter (“bytecode”) uses the hax library to write operators directly in low-level bytecode.

TABLE 14
Settings to synthesize SQL engine using Pyarrow.

| Property | Value |
|---|---|
| Prefix | import pyarrow as pa |
| | import pyarrow.compute as pc |
| | import pyarrow.csv as csv |
| Table | a pyarrow Table |
| Column | a pyarrow Array |
| Null | None |
| Boolean | pa.bool_( ) |
| Integer | pa.int64( ) |
| Float | pa.float64( ) |
| String | pa.string( ) |

Synthesis statistics were determined for SQL engines modifying operator behavior with (1-Shot) and without (0-Shot) one user-defined sample operator. More particularly, synthesis statistics were determined for the first six engines, reporting the number of characters processed by GPT-3 Codex, the number of debugging rounds (i.e., iterations of the main loop in Algorithm 1), synthesis time, number of operator implementations synthesized, the number of code lines as well as the ratio of non-default operators in the resulting engine. GPT-3 pricing is based on the number of tokens processed. While GPT-3 Codex is not yet publicly available, assuming a similar pricing to the base version of GPT-3 (USD 0.02 per 1,000 tokens at the time the experiments were performed), the character counts would translate into synthesis costs of few dollars per engine. The median success ratio (i.e., ratio of correct operators synthesized) is 81% when using natural language instructions alone (i.e., 0-Shot). It increases to 90% if one sample operator is provided (1-Shot). Note that the resulting engines work out of the box on all test cases, including TPC-H queries, even if not all operators are successfully synthesized (as GenesisDB automatically switches to default implementations otherwise). The largest engine has slightly above 2,000 code lines (counting only operator implementations).

Table 15 summarizes synthesis results for the remaining engines. Synthesizing operators that produce specialized output is relatively quick (one to two hours) with a similar success ratio as before (76% in a zero-shot setting). Synthesizing engines that change the data format or processing mechanisms significantly is harder and requires code samples (one-shot setting). Still, GenesisDB can synthesize up to 48% of operators in these scenarios, reducing the amount of code to write by users.

TABLE 15
Synthesis statistics for output (upper part, zero-shot setting)
and processing (lower part, one-shot setting) variants.

| Engine | #Chars | #Rounds | Time (s) | LoC | Suc. (%) |
|---|---|---|---|---|---|
| Compl. | 398K | 21 | 1 h 17 m | 1759 | 93 |
| Book | 932K | 46 | 1 h 45 m | 1281 | 70 |
| Long | 624K | 36 | 1 h 18 m | 2357 | 81 |
| Tutorial | 899K | 44 | 2 h 6 m | 2021 | 76 |
| Wiki | 840K | 41 | 1 h 45 m | 1937 | 72 |
| Arrow | 1.6M | 33 | 2 h 54 m | 883 | 48 |
| Bytecode | 1.6M | 48 | 2 h 27 m | 1362 | 46 |
| Parallel | 2.8M | 55 | 5 h 37 m | 1155 | 43 |

While GenesisDB can automatically detect incorrect operator output via test cases, it cannot automatically test for custom behavior. Table 16 reports results of manual analysis of generated code. Each column represents one group of operators (Boolean comparisons, aggregates, and joins) for which the first non-default operator (in the order they appear in the synthesized engine) is analyzed. A checkmark means that this operator implements the behavior described in the instructions. This check entails, for instance, checking links to Wikipedia articles or SQL tutorials and ensuring that the content relates to the operator indeed. It also entails verifying that an operator uses specific libraries for processing (e.g., hax), uses parallelization, or exploits Pyarrow functionality for processing. A dash (-) means that all operators in that group are default implementations. A high percentage of 81% of analyzed non-default operators implement the desired functionality indeed. For example, the join operator of the tutorial engine prints out the corresponding link, all operators of the debug engine print out names and data samples, and the operators of the arrow engine typically use the pyarrow.compute package to implement operations.

TABLE 16
Results of manual code verification.

| Engine | Mode | Comparison | Aggregate | Join |
|---|---|---|---|---|
| Checkpoint | 0/1-Shot | x✓ | x✓ | x✓ |
| Data | 0/1-Shot | x✓ | x✓ | x✓ |
| Debug | 0/1-Shot | ✓✓ | ✓✓ | ✓✓ |
| Education | 0/1-Shot | ✓✓ | ✓✓ | ✓✓ |
| Performance | 0/1-Shot | ✓✓ | ✓✓ | ✓✓ |
| Progress | 0/1-Shot | ✓✓ | x✓ | ✓✓ |
| Complexity | 0-Shot | ✓ | x | ✓ |
| Book | | x | x | ✓ |
| Long | | ✓ | ✓ | ✓ |
| Tutorial | | ✓ | ✓ | ✓ |
| Wikipedia | | ✓ | x | ✓ |
| Arrow | 1-Shot | ✓ | ✓ | ✓ |
| Bytecode | | ✓ | ✓ | — |
| Parallel | | ✓ | ✓ | — |

Table 17 shows the results of an ablation study, synthesizing the engine described in Table 6 while leaving out the suffix, without a default engine. The table compares the main version of GenesisDB to two ablated variants, the first one ordering tests randomly, the second one additionally selecting operators to fix randomly. Clearly, both of the aforementioned features contribute to the performance of GenesisDB. GenesisDB is optimized for high customizability, rather than performance, in terms of data representation (.csv) and implementation language (Python).

TABLE 17
Results of ablation study (timeout: 6 hours).

| Metric | GenesisDB | Sorting | Debugging |
|---|---|---|---|
| Generation Time | 4 h 5 m | 5 h 24 m | ≥ 6 h |
| Debugging Rounds | 16 | 29 | ≥35 |
| Chars Processed | 973K | 3M | ≥3.6M |
| Custom Operators | 89% | 56% | 57% |
| Passed Tests | 100% | 100% | 80% |

Performance results were also obtained for TPC-H queries, comparing GenesisDB (in arrow configuration and with simple Python lists as in-memory data representation) to Postgres 10.22 with primary key or primary and foreign key indexes and SQLite 3.36.

None of the GenesisDB variants incur timeouts whereas SQLite and Postgres with partial indexes incur two timeouts each with more than 10 minutes of processing time. Considering time for data loading and indexing (114 seconds) as well as execution time (24 seconds), Postgres with primary and foreign key indexes is still about twice as fast as the best GenesisDB configuration (244 seconds) while GenesisDB is faster than Postgres with primary key indexes only as well as SQLite (due to timeouts). Overall, GenesisDB can achieve comparable performance to some popular systems such as SQLite, making it practical, e.g., to quickly prototype novel features on moderately sized databases.

As disclosed herein, CodexDB synthesizes Python code for query processing according to natural language instructions, and has been shown to work well on queries of simpler benchmarks such as WikiSQL and SPIDER, although it is unable to synthesize correct code for any of the TPC-H queries, allowing up to 10 synthesis tries per query which took 312 seconds in average. However, GenesisDB provides an enhanced system that allows customization via natural language instructions for TPC-H queries.

GenesisDB enables lay users to rewrite the code of its core engine via short natural language commands. As shown in the experiments, this approach works well for features such as custom SQL debugging support, performance logging, data analysis, or progress updates. The resulting engines support a broad range of SQL queries and implement desired functionality for most operators. For instance, this approach enables fast, user-driven prototyping, in which lay users invent and immediately test new features on small data sets, then pass on the most popular ones to developers for a more efficient and more complete re-implementation. Similar to GitHub's CoPilot, GenesisDB may also support developers by reducing the amount of code to write for a new engine. More broadly, GenesisDB shows that generative AI can help to shorten the path from idea to implementation in database systems.

It should be understood that the particular arrangements shown and described in conjunction with FIGS. 1 through 14 herein, including the above descriptions of CodexDB and GenesisDB, are presented by way of illustrative example only, and numerous alternative embodiments are possible. The various embodiments disclosed herein should therefore not be construed as limiting the scope of the disclosure in any way. Numerous alternative arrangements of AI systems and their associated database code generation functionality as disclosed herein can be utilized in other embodiments. Those skilled in the art will also recognize that alternative processing operations and associated system configurations can be used in other embodiments.

Accordingly, the particular features and advantages of illustrative embodiments as described in conjunction with FIGS. 1 through 14 above may or may not be present in other embodiments.

It is therefore possible that other embodiments may include additional or alternative system elements, relative to the entities of the illustrative embodiments. Accordingly, the particular system configurations and associated algorithm implementations can be varied in other embodiments.

For example, in some embodiments, an apparatus illustratively comprises at least one processing device comprising a processor coupled to a memory, with the at least one processing device being configured to receive natural language input from one or more user devices wherein the natural language input comprises or represents one or more problems to be solved, to translate at least part of the natural language input into a database query or database code at partially via a natural language to database code method (e.g., a text-to-SQL method), to apply the natural language and/or the translated database query or code to an AI system, to generate programming language code at least partially via the AI system based at least part on the natural language input and/or the translated database query or code, and to execute the programming language code via a compiler or an interpreter to generate one or more results to solve at least part of the one or more problems.

As another example, a method in one or more embodiments illustratively comprises receiving natural language input from one or more user devices wherein the natural language input comprises or represents one or more problems to be solved, translating at least part of the natural language input into a database query or database code at partially via a natural language to database code method (e.g., a text-to-SQL method), applying the natural language and/or the translated database query or code to an AI system, generating programming language code at least partially via the AI system based at least part on the natural language input and/or the translated database query or code, and executing the programming language code via a compiler or an interpreter to generate one or more results to solve at least part of the one or more problems. The method is illustratively performed by at least one processing device comprising a processor coupled to a memory.

As yet another example, a computer program product in some embodiments illustratively comprises a non-transitory processor-readable storage medium having stored therein program code of one or more software programs, wherein the program code, when executed by at least one processing device comprising a processor coupled to a memory, causes the at least one processing device to receive natural language input from one or more user devices wherein the natural language input comprises or represents one or more problems to be solved, to translate at least part of the natural language input into a database query or database code at partially via a natural language to database code method (e.g., a text-to-SQL method), to apply the natural language and/or the translated database query or code to an artificial intelligence (AI) system, to generate programming language code at least partially via the AI system based at least part on the natural language input and/or the translated database query or code, and to execute the programming language code via a compiler or an interpreter to generate one or more results to solve at least part of the one or more problems.

In these and other embodiments disclosed herein, the AI system illustratively comprises a language model, and more particularly a large language model (LLM).

For example, the AI system may comprise one or more of a GPT or other type of generative transformer, a Bidirectional Encoder Representations from Transformers (BERT) model, or other transformer-based language model, as well as combinations of these and/or other models.

The above-noted programming language code may comprise, for example, Python, C, C++, C#, Java, JavaScript, or any combination thereof, as well additional or alternative types of programming code.

In some embodiments, the natural language input is relating at least in part to data of one or more databases.

Additionally or alternatively, the data of one or more databases in some embodiments is associated with one or more problems to be solved.

In some embodiments, the above-noted example apparatus, method and/or computer program product are illustratively further configured to verify the generated programming language code, the generated one or more results, or both, at least in part by comparing query results, generated by executing the code, to query results generated by a reference database management system.

Additionally or alternatively, the generated programming language code in some embodiments comprises a code length of at least 50 lines (or at least 100 lines, 200 lines, 300 lines, 400 lines, 500 lines, 600 lines, 700 lines, 800 lines, 900 lines, or 1000 lines, etc.) as appropriate to the particular needs of a given application.

In some embodiments, the above-noted example apparatus, method and/or computer program product are illustratively further configured to solve a plurality of problems with an average correctness of at least 60%, at least 70%, at least 75%, or at least 80%.

These and other embodiments can additionally or alternatively comprise displaying intermediate results, final results, or both, and/or generating one or more prompts.

In some embodiments, at least part of the generated programming language code is used as one or more samples in one or more prompts to generate updated programming language code. The accuracy rate of the updated programming language code may be higher than that of the generated programming language code.

Additionally or alternatively, some embodiments are configured to mix at least part of the programming language code generated via the AI system with boilerplate code to be executed to generate results.

In some embodiments, the one or more problems include problems comprising data associated with one or more databases.

A given processing device or other component of an information processing system as described herein is illustratively configured utilizing a corresponding processing device comprising a processor coupled to a memory. The processor executes software program code stored in the memory in order to control the performance of processing operations and other functionality. The processing device also comprises a network interface that supports communication over one or more networks.

The processor may comprise, for example, a microprocessor, an ASIC, an FPGA, a CPU, a GPU, a TPU, an ALU, a DSP, or other similar processing device component, as well as other types and arrangements of processing circuitry, in any combination. For example, at least a portion of the functionality of at least one AI system and its associated algorithms for generating database code, provided by one or more processing devices as disclosed herein, can be implemented using such circuitry.

The memory stores software program code for execution by the processor in implementing portions of the functionality of the processing device. A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, ROM, flash memory, magnetic memory, optical memory, or other types of storage devices in any combination.

As mentioned previously, articles of manufacture comprising such processor-readable storage media are considered embodiments of the present disclosure. The term “article of manufacture” as used herein should be understood to exclude transitory, propagating signals. Other types of computer program products comprising processor-readable storage media can be implemented in other embodiments.

In addition, embodiments of the present disclosure may be implemented in the form of integrated circuits comprising processing circuitry configured to implement processing operations associated with implementation of a machine learning system or other type of AI system for generating database code as disclosed herein.

An information processing system as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Another illustrative embodiment of a processing platform that may be used to implement at least a portion of an information processing system as disclosed herein comprises a plurality of processing devices which communicate with one another over at least one network. Each processing device of the processing platform is assumed to comprise a processor coupled to a memory. A given such network can illustratively include, for example, a global computer network such as the Internet, a WAN, a LAN, a satellite network, a telephone or cable network, a cellular network such as a 4G or 5G network, a wireless network implemented using a wireless protocol such as Bluetooth, WiFi or WiMAX, or various portions or combinations of these and other types of communication networks.

Again, these particular processing platforms are presented by way of example only, and an information processing system may include additional or alternative processing platforms, as well as numerous distinct processing platforms in any combination, with each such platform comprising one or more computers, servers, storage devices or other processing devices.

A given processing platform implementing an AI system as disclosed herein can alternatively comprise a single processing device, such as a computer, mobile telephone or other processing device, that implements not only the AI system but also at least one user device and one or more database management systems. It is also possible in some embodiments that one or more such system elements can run on or be otherwise supported by cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components of the system as disclosed herein can be implemented at least in part in the form of one or more software programs stored in memory and executed by a processor of a processing device. For example, certain functionality disclosed herein can be implemented at least in part in the form of software.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts.

It should again be emphasized that the embodiments of the present disclosure as described herein are intended to be illustrative only. Other embodiments of the present disclosure can be implemented utilizing a wide variety of different types and arrangements of information processing systems, processing devices, AI systems, interfaces, database code, database management systems and additional or alternative components than those utilized in the particular illustrative embodiments described herein, and in numerous alternative processing contexts. In addition, the particular assumptions made herein in the context of describing certain embodiments need not apply in other embodiments. These and numerous other alternative embodiments will be readily apparent to those skilled in the art.

What is claimed is:

1. An apparatus comprising:
at least one processing device comprising a processor coupled to a memory;
the at least one processing device being configured:
to receive natural language input from one or more user devices relating at least in part to data of one or more databases;
to apply the natural language input to an artificial intelligence (AI) system;
to generate in the AI system database code for the one or more databases based at least in part on the natural language input; and
to execute the generated database code against at least a portion of the one or more databases.

2. The apparatus of claim 1 wherein executing the generated database code comprises providing the generated database code to a database management system associated with the one or more databases for execution therein.

3. The apparatus of claim 1 wherein receiving natural language input from one or more user devices comprises receiving the natural language input in association with at least one database query, and wherein the at least one processing device is further configured to decompose the at least one database query into a sequence of processing steps formulated in natural language using one or more corresponding text templates.

4. The apparatus of claim 3 wherein the at least one processing device is further configured to generate one or more prompts for application to the AI system at least in part by interleaving at least a portion of the sequence of processing steps with one or more user-provided instructions of the natural language input, wherein at least one of the one or more prompts further comprises at least one of (i) information characterizing one or more database schema, (ii) information characterizing one or more physical data properties, (iii) one or more generic instructions regarding corresponding relational operators, and (iv) one or more code samples.

5. The apparatus of claim 4 wherein applying the natural language input to the AI system comprises applying the one or more prompts to the AI system for generation of the database code therefrom.

6. The apparatus of claim 1 wherein the AI system is configured in accordance with a Generative Pretrained Transformer (GPT) model.

7. The apparatus of claim 1 wherein receiving natural language input from one or more user devices comprises receiving at least one of one or more general instructions in natural language and one or more per-step instructions in natural language via at least one user interface of the at least one processing device.

8. The apparatus of claim 7 wherein a given one of the general instructions comprises an instruction specifying at least one particular library to be utilized in processing at least one database query.

9. The apparatus of claim 7 wherein a given one of the per-step instructions comprises an instruction specifying customized logging output.

10. The apparatus of claim 1 wherein the at least one processing device is further configured to receive termination condition information from the one or more user devices, the termination condition information specifying one or more termination criteria associated with automated verification operations performed on generated database code by the AI system, and wherein generating the database code comprises generating the database code in a manner that complies with the one or more termination criteria specified in the received termination condition information.

11. The apparatus of claim 1 wherein the at least one processing device is further configured to implement an automated debugging system for debugging at least portions of the database code.

12. The apparatus of claim 11 wherein the automated debugging system is configured to apply a probabilistic model to identify one or more portions of the database code that have at least a threshold likelihood of being incorrect and to control regeneration of the one or more identified portions.

13. The apparatus of claim 11 wherein the automated debugging system is configured to schedule execution of one or more test cases in conjunction with identifying one or more portions of the database code that have at least a threshold likelihood of being incorrect.

14. The apparatus of claim 1 wherein the at least one processing device is further configured to utilize at least a portion of the generated database code as a code sample for use in generation of additional database code by the AI system.

15. The apparatus of claim 1 wherein the at least one processing device is further configured, for each of one or more database queries:
to obtain a first query result for the database query utilizing a reference database management system;
to obtain a second query result for the database query utilizing a database management system comprising the generated database code;
to compare the first and second query results; and
to determine correctness of the generated database code based at least in part on the comparison.

16. The apparatus of claim 1 wherein the at least one processing device is further configured to combine the database code generated by the AI system with additional database code.

17. A method comprising:
receiving natural language input from one or more user devices relating at least in part to data of one or more databases;
applying the natural language input to an artificial intelligence (AI) system;
generating in the AI system database code for the one or more databases based at least in part on the natural language input; and
executing the generated database code against at least a portion of the one or more databases;
wherein the method is performed by at least one processing device comprising a processor coupled to a memory.

18. The method of claim 17 wherein receiving natural language input from one or more user devices comprises receiving the natural language input in association with at least one database query, wherein the method further comprises decomposing the at least one database query into a sequence of processing steps formulated in natural language using one or more corresponding text templates, and generating one or more prompts for application to the AI system at least in part by interleaving at least a portion of the sequence of processing steps with one or more user-provided instructions of the natural language input, wherein at least one of the one or more prompts further comprises at least one of (i) information characterizing one or more database schema, (ii) information characterizing one or more physical data properties, (iii) one or more generic instructions regarding corresponding relational operators, and (iv) one or more code samples, and wherein applying the natural language input to the AI system comprises applying the one or more prompts to the AI system for generation of the database code therefrom.

19. A computer program product comprising a non-transitory processor-readable storage medium having stored therein program code of one or more software programs, wherein the program code, when executed by at least one processing device comprising a processor coupled to a memory, causes the at least one processing device:
to receive natural language input from one or more user devices relating at least in part to data of one or more databases;
to apply the natural language input to an artificial intelligence (AI) system;
to generate in the AI system database code for the one or more databases based at least in part on the natural language input; and
to execute the generated database code against at least a portion of the one or more databases.

20. The computer program product of claim 19 wherein receiving natural language input from one or more user devices comprises receiving the natural language input in association with at least one database query, wherein the program code when executed further causes the at least one processing device to decompose the at least one database query into a sequence of processing steps formulated in natural language using one or more corresponding text templates, and to generate one or more prompts for application to the AI system at least in part by interleaving at least a portion of the sequence of processing steps with one or more user-provided instructions of the natural language input, wherein at least one of the one or more prompts further comprises at least one of (i) information characterizing one or more database schema, (ii) information characterizing one or more physical data properties, (iii) one or more generic instructions regarding corresponding relational operators, and (iv) one or more code samples, and wherein applying the natural language input to the AI system comprises applying the one or more prompts to the AI system for generation of the database code therefrom.
